(19) United States
(12) Patent Application Publication
(10) Pub. No.: US 2024/0294405 A1
(43) Pub. Date: Sep. 5, 2024

(54) MICROBUBBLE-ENHANCED COLD PLASMA WATER ACTIVATION

(71) Applicant: The Governors of the University of Alberta, Edmonton (CA)

(72) Inventors: Xuehua Zhang, Edmonton (CA); Yawen Gao, Edmonton (CA)

(73) Assignee: The Governors of the University of Alberta, Edmonton (CA)

(21) Appl. No.: 18/440,027

(22) Filed: Feb. 13, 2024

Related U.S. Application Data
(60) Provisional application No. 63/445,135, filed on Feb. 13, 2023.

(51) Int. Cl. C02F 1/46; A01G 9/24; B01F 25/312; B01F 101/00; C02F 1/30

(52) U.S. Cl. CPC C02F 1/4608; B01F 25/31242; C02F 1/30; A01G 9/243; B01F 2101/305; B01F 2215/0431; B01F 2215/045

(57) ABSTRACT

A high efficiency plasma activation system for large scale treatment of liquid including a liquid tank; a pump having an inlet fluidly connected to an outlet of the liquid tank; a self-suction mechanism having a liquid inlet fluidly connected to an outlet of the pump, an air inlet, and an outlet fluidly connected to an inlet of the liquid tank; and a plasma generator having a plasma discharge nozzle positioned adjacent to the air inlet of the self-suction mechanism and configured to discharge gas phase plasma into the air inlet of the self-suction mechanism and introduce micro/nano bubbles (MNBs) into a flow of liquid to be treated to where the MNBs collapse to agitate and impregnate the liquid with a gas, for highly efficient plasma activation of liquid on a large scale as a green and sustainable technology for disinfection in the food industry and agriculture.

### RELATED APPLICATIONS

This application claims priority benefit of U.S. Provisional Application Ser. No. 63/445,135 filed 13 Feb. 2023; the contents of which are hereby incorporated by reference.

### FIELD OF THE INVENTION

The present invention relates to water treatments, and more particularly, it relates to bubble-enhanced plasma technology to activate a flow of water to achieve a high activation efficiency during cold plasma activation of water.

### BACKGROUND OF THE INVENTION

Water scarcity caused by climate change and industrial over-development is a serious issue globally. A large number of water treatment technologies have been employed to process wastewater for meeting the standards for water reuse and discharge[1]. Traditional methods include biological oxidation, physical adsorption and chemical coagulation [2]. Novel methods, also known as the advanced oxidation processes (AOPs), include ozone treatment, H₂O₂ oxidation, Fenton reaction [3, 4], photo-oxidation, and plasma process [5-8]. However, the majority of conventional methods require addition of chemicals or catalysts, which may cause a secondary pollution and high cost.

Cold plasma (or non-thermal plasma), generally derived from electrical discharge, is considered as a promising AOP technology that is chemical-free without harmful byproducts in the environment. The technology of plasma activation has been widely used in wastewater and medical treatments [2], food processing [9], seeds germination [10], plant growth and microbial deactivation [12, 13]. Plasma activated water (PAW) contains abundant reactive species after plasma activation, such as ·OH, HO₂, H₂O₂, O₃, NOₓ [2]. Properties of PAW, like pH, redox potential, conductivity and the concentration of reactive oxygen and nitrogen species (ROS and RNS) have been significantly changed in the activation. The majority of reactive oxygen species are strong oxidizing agents. Moreover, the presence of nitrogen reactive species creates an acidic environment in PAW with a high antibacterial feature and strong capability to destroy harmful organic pollutants. Meanwhile, PAW is considered as a liquid chemical fertilizer since nitrogen ionization provides nitrates contents for seed germination and plant growth [14].

Various approaches have been reported for water activation, such as corona discharge [15, 16], dielectric barrier discharge (DBD) [17, 18] and microwave irradiation [19]. Gaseous plasma can be ignited in gas or liquid phase, at gas-liquid or gas-solid interfaces. Free radicals, ultraviolet radiation, shock waves, unpaired electrons, ions and others, oxidize or mineralize the chemical pollutants [20].

However, the efficiency of activation faces several hurdles since the transfer of these gaseous reactive species to water is limited. In other words, only a small amount of reactive species can pass through the gas-liquid interface and react with the targeted molecules in the bulk.

A few works have combined plasma technology with bubbles to enhance efficiency in the degradation of acetic acid [26], antibiotics removal [27-29], cyanide and aniline degradation [30, 31] and pathogen inactivation [32]. Due to the diverse methods on the formation of bulk bubbles and plasma, their experimental configurations are quite different. For example, plasma was supplied to a microbubble generator to enhance the mass transfer of reactive species in liquid [33]. However, the entire treatment system was quite complex [33]. In another work [31], the treatment volume of solution was limited to several hundred milli-liters. In another configuration, bubbles exit from a horizontal tube immersed in water where a plasma jet was discharged perpendicularly to the clouds of microbubbles. Although the treatment capacity of the configuration is large (˜10 L), the misalignment of the plasma jet and the exit of the tube could impact the efficiency of activation [23]. Up to now, designs for water treatment are suitable for the working bench in a closed system. There is no report of bubble-enhanced activation design for a flow of water to achieve a large volume production in a short time.

Thus, there exists a need for a highly efficient plasma activation system for efficient activation of water on a large scale as a green and sustainable technology for disinfection, food industry and agriculture.

### SUMMARY OF THE INVENTION

The present invention provides a high efficiency, green, and sustainable plasma activation system for large scale treatment of liquid for disinfection, food production and storage, nitrogen fixation in agriculture and in ammonia synthesis, and for materials modification. The inventive system includes a liquid tank having an inlet and an outlet; a pump having an inlet and an outlet, the inlet of the pump fluidly connected to the outlet of the liquid tank; a self-suction mechanism having a liquid inlet fluidly connected to the outlet of the pump, an air inlet, and an outlet fluidly connected to the inlet of the liquid tank, the liquid inlet, the air inlet, and the outlet joined at a throat; and a plasma generator having a plasma discharge nozzle positioned adjacent to the air inlet of the self-suction mechanism and configured to discharge gas phase plasma into the air inlet of the self-suction mechanism and introduce micro/nano bubbles (MNBs) into a flow of liquid to be treated to where the MNBs collapse to agitate and impregnate the liquid with a gas. According to embodiments, the self-suction mechanism is a Venturi tube with an air inlet having an inner diameter of 1 to 4 mm and a length of 5 mm to 20 mm and an outlet having a length of 5 mm to 80 mm. According to embodiments, the system has a degradation efficiency of 80% after two hours of treatment in the system.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A is a schematic drawing of an experimental setup for small-scale treatment according to embodiments of the present invention;

FIG. 1B is a schematic diagram of a proposed Venturi channel according to embodiments of the present invention, in which D is the diameter of the inlet and outlet of the tube, d and e are the diameters of the neck and of the air suction opening, respectively, α and β are the angles of contraction and exit, respectively, L is the length from the shrinkable and expandable areas [34], and the geometrical sizes are given in Table 3;

FIG. 1C shows a physics model and applied boundary conditions of the Venturi tube structure for numerical calculation;

FIG. 1D shows a 3D computational structured mesh layout of the Venturi tube according to embodiments of the present invention;

FIG. 2A shows a schematic drawing of a bubbling system for a dye degradation process according to embodiments of the present invention;

FIG. 2B shows a schematic drawing of plasma discharged above the surface of the liquid for a dye degradation process according to embodiments of the present invention;

FIG. 2C shows a schematic drawing of the presence of microbubbles and plasma discharged above liquid surface for a dye degradation process according to embodiments of the present invention;

FIG. 2D shows a schematic drawing of plasma and microbubbles combined in a hydrodynamic Venturi tube for a dye degradation process according to embodiments of the present invention;

FIG. 2E is a graph showing degradation rates for the four configurations shown in FIGS. 2A-2D, where degradation rates are calculated using Equation 2 at 30 min (Liquid flow rate: 5 L/min; Liquid volume: 1 L; Initial concentration of dye: 10 mg/L);

FIG. 3A shows a high-speed visualizing experiment of bubble generation and transport in the Venturi tube according to embodiments of the present invention with bubble generation and transport in throat and divergent sections;

FIG. 3B shows four graphs showing bubble size distribution in a Venturi channel for various water flow rates Q_{w} wherein each case at least 1000 bubbles are counted;

FIG. 4 shows a set up for MO degradation in a large-scale treatment according to embodiments of the present invention and degradation efficiency of MO where the liquid volume is 17 L;

FIGS. 5A, 5C, and 5E are graphs showing evaluation on the degradation of MO solution prepared by tap water while FIGS. 5B, 5D, and 5F are graphs showing evaluation on the degradation of MO solution prepared by pure water in terms of absorbance spectra (FIGS. 5A and 5B), degradation efficiency at high voltage discharge (FIGS. 5C and 5D) and degradation efficiency at low voltage discharges (FIGS. 5E and 5F), there the initial concentration of MO solution is 10 mg/L and where results of FIG. 5A and FIG. 5B are opted from FIGS. 5E and 5F at 5 L/min, respectively;

FIG. 6A is a graph showing time evolution of pH and conductivity in tap water;

FIG. 6B is a graph showing time evolution of pH and conductivity in MO solution prepared by tap water;

FIG. 6C is a graph showing time evolution of pH and conductivity in pure water;

FIG. 6D is a graph showing time evolution of pH and conductivity in MO solution by pure water prepared;

FIG. 7 is a graph showing the cold air plasma detected by the optical emission spectrum and presenting the reactive oxygen and nitrogen species (RONS);

FIG. 8A shows an electron spin resonance spectra of pure water mixed with DMPO at 20 mM after combined treatment, with the spectrum of spin trap adduct DMPOX obtained with high voltage discharge (15 kV);

FIG. 8B shows an electron spin resonance spectra of pure water mixed with DMPO at 100 mM after combined treatment, with the spectrum of spin trap adduct DMPOX obtained with high voltage discharge (15 kV);

FIG. 8C shows differences on the chemical structure of DMPO, DMPO-OH and DMPOX.

FIG. 9 shows a series of surface temperature distribution images around the cold plasma nozzle performed in air under the combined treatment (part of FIG. 1A), where a bottle of water in a beaker is used as a reference object and as time went by, the temperature around the plasma nozzle increased, and the highest temperature is found at the tip. The surface temperature of the central metal electrode is kept around 55° C., and as plasma discharge initiated, the temperature of bubbling water increased within 30 min, and the liquid flow rate applied is 5 L/min;

FIG. 10A shows a temporal evolution of the volume flow rate of self-suctioned air for two cases of Q_{w}=5 L/min and Q_{w}=8 L/min where data are collected from the whole outlet;

FIG. 10B shows a mean volume flow rate of self-suctioned air as a function of the water flow rate, where the error bars represent the standard deviation from five statistics;

FIG. 10C shows time-averaged pressure field under the water flow rate of 5 L/min, where the top shows the front view of the vertical section, while the bottom shows the top view of the cross section;

FIG. 10D shows axial profiles of static pressure at three locations, as depicted in FIG. 10C, and where the inset presents a zoom of the local data around the nadir pressure;

FIG. 10E shows the global minimum absolute pressure and hydraulic loss coefficient as a function of inlet Reynolds number;

FIG. 11A shows numerical simulations of gas-liquid two-phase flow in Venturi tube with temporal evolution of instantaneous isosurface of gas volume fraction under the initial water flow rate of 3 L/min, and where the color on the surface of the bubbles represents the speed gradient;

FIG. 11B shows snapshots showing the velocity vectors around the bubbles at different instants;

FIGS. 12A and 12C show cross-sectional files of the time-averaged streamlines superposed by velocity field for two cases of (a-b) Q_{w}=5 L/min and (c-d) Q_{w}=8 L/min, where vorticity contour levels show the flow structure developing in the Venturi channel;

FIGS. 12B and 12D show the volume-averaged turbulence kinetic energy for two cases of (a-b) Q_{w}=5 L/min and (c-d) Q_{w}=8 L/min, where vorticity contour levels show the flow structure developing in the Venturi channel;

FIG. 13A is a schematic diagram of the experiment setup for PAW treatment for decolorization of methyl orange (MO) under the energy supply by solar at the outside assisted by portable power station (1. water tank; 2. transfer tube; 3. peristaltic pump; 4. Cavitation tube; 5. quartz tube; 6. plasma nozzle; 7. battery; 8. solar panels);

FIG. 13B is a graph showing the results on degradation efficiency after plasma treatment under sunshine for 30 minutes using the set up of FIG. 13A;

FIG. 14A is a photograph showing peanut seedlings in trays of PAW and tap water, respectively;

FIG. 14B shows a photograph showing all harvest products of mature peanut seedlings from the PAW and tap water trays of FIG. 14A; and

FIG. 14C is a graph showing distribution in terms of average length, total fresh weight and total dry weight for peanut seedlings.

### DESCRIPTION OF THE INVENTION

The present invention has utility as a highly efficient plasma activation system for activation of continuous liquid flow as a green and sustainable technology for disinfection, food industry, agriculture, chemical conversion, and material modification. The inventive system uses bubble-enhanced cold plasma activation to greatly enhance the efficiency in plasma activation. The discharge is in gas phase, including air, or controlled gas composition. Small bubbles have high mass transfer efficiency or high dissolution rate, high surface-to-volume ratio, long residence time in liquid, and high internal pressure [21-24]. Once bubbles combine with plasma in water treatment, the small bubbles shrink, dissolve, or collapse in the liquid flow. As a result, highly reactive species are released into the liquid flow to react with aimed molecules. Additionally, in certain conditions, microbubbles combine with dispersed chemicals, thereby enhancing the plasma treatment and changing the complexity of the aqueous surface [25].

According to embodiments, microbubble generation through cavitation in a liquid flow significantly improves the activation efficiency by cold plasma treatment with the same energy input. Comprehensive characterization is performed of the physicochemical properties of PAW produced in the flow water, which are consistent with the product obtained from other activation methods reported in literature. High speed images complemented with 3D computational fluid dynamic simulations are employed to gain insights into the gas volume fraction, pressure, velocity distributions and bubble behaviors in the cavitation tube. The high efficiency of activation from microbubbles expands PAW as a green, sustainable, and chemical-free technology to the large scale applications in food industry, disinfection, and agriculture.

Microbubble-enhanced cold plasma activation is based on the fast and efficient mass transfer through the large area of the gas-water interface and the rapid mixing created by bubble dynamics. The bubbles form in a type of venturi tube through self-suction. Microubbbles provide enormous surface area for fast impregnation of the gaseous species into water. Rapid collapse of these tiny bubbles further enhances the mass transfer of gases into the water due to induced agitation from high internal pressure. Embodiments of the present invention address the current challenges of existing PAW systems and achieve large-volume PAW generation.

The intrinsically slow step of mass transfer across the gas-liquid interface is typically solved by pressurizing the gas, passing gas through the sparger to increase the gas-liquid contact area, and extending the exposure time or rapidly stirring the liquid. The present invention is uniquely positioned to overcome the current barriers by water activation in flow systems. The activation utilized in embodiments of the present invention leverages MNB formation and self-suction mechanism to facilitate gas transfer into water. MNBs possess a high surface-to-volume ratio and high internal pressure and induce violent agitation in water from their rapid collapse for effective gas impregnation into water.

Compared to underwater discharge, in in the present invention, the discharge is in the air phase to generate species for activation of water flowing through self-suction. Such an activation process has proven to be advantageous over a configuration with the electrode in water. Distinct from the limited discharge in the water of dissolved gases, the air in the gas phase during discharge can be converted to RNOS. Furthermore, according to embodiments of the present invention, the electrode of the cold plasma device is protected from fouling as the water to be treated is spatially separated from the discharging device. In this way, no part of the device is in contact with water, therefore eliminating fouling issues and extending the lifetime of the device, and enabling treatment of wastewater containing solids, oils, or other chemicals, and treatment of liquids that are not water. Discharge in the gas phase can avoid the fouling issue and extend the lifetime of the electrodes and the durability of the activation device. Moreover, the transport of active species from plasma discharge is directed into the water flow via a Venturi tube. The number and the dimension of the gas inlets on the Venturi tube can be varied to accommodate the requirements by using one or multiple electrodes by corona discharge or other discharge methods. There is no need for an extra gas flow to enforce the transport of gas into water, eliminating the requirements for compressed gas in current commercial plasma active devices. The gas type can be controlled by connecting the gas inlet to the gas supply.

Furthermore, the self-suction mechanism of the present invention enables portability of PAW production devices. Distinct from the limited discharge in the water of dissolved nitrogen and oxygen gases, abundant nitrogen and oxygen in the air are present during discharge and can be converted to RNOS. Together, all nitrogen and oxygen species provide a synergistic effect to create active nitrogen species to enhance plant growth or degrade chemical residues in wastewater.

According to embodiments, the activation process can be powered by a solar panel, feasible for installation in the field as a stand-alone device, thanks to the high energy efficiency for discharge in air.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

As used herein. “self-suction” refers to the property of automatically removing gas from a contained portion, such as a tube interior and filling the contained portion with liquid without resort to manual priming.

### Materials and Methods

Methyl Orange (C₁₄H₁₄N₃O₃S·Na, molecular weight=327 g/mol, 98%, maximal absorption wavelength=464 nm) is purchased from Hongjie Technology in China and is chosen as a model compound to monitor the dye degradation process. The initial concentration of all methyl orange (MO) solutions is 10 mg/L. In order to make MO fully dissolved in the aqueous, the mixture of MO solute and water is sonicated for 5 min prior to the treatment by cold plasma.

Tap water (natural pH=7.73, see Table 1) is obtained from the tap located at the lab at Tsinghua University, Beijing, China. Pure water is taken from a water purification system (Milli-Q, Merck, Germany) with an electrical conductivity of 18.2 MΩ·cm and natural pH of 6.23 at room temperature of 25° C.

The chemical species in tap water used in this study is provided in Table 1.

TABLE 1

| Items | Tap water^{a} |
|---|---|
| pH | 7.37-8.15 |
| Ions | Calcium hardness: 125-366 mg CaCO₃/L |
| | Sulphate dissolved: 24.2-87.3 mg/L |
| | Chloride dissolved: 9.1-63.1 mg/L |
| | Nitrate (as N) dissolved: 1.0-8.3 mg/L |
| | Fluoride dissolved: 0.13-0.35 mg/L |
| | Total dissolved solids: 154-560 mg/L, etc. |

### EXPERIMENTAL PROCEDURES

### Experimental Rig for Water Treatment

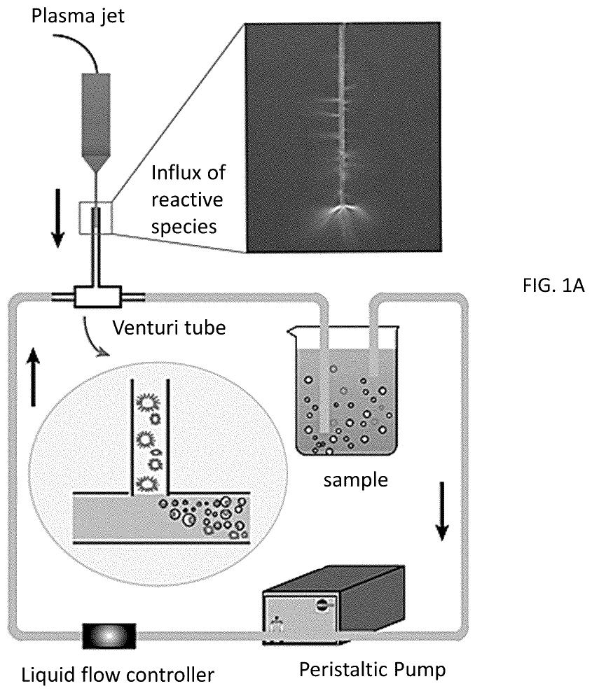

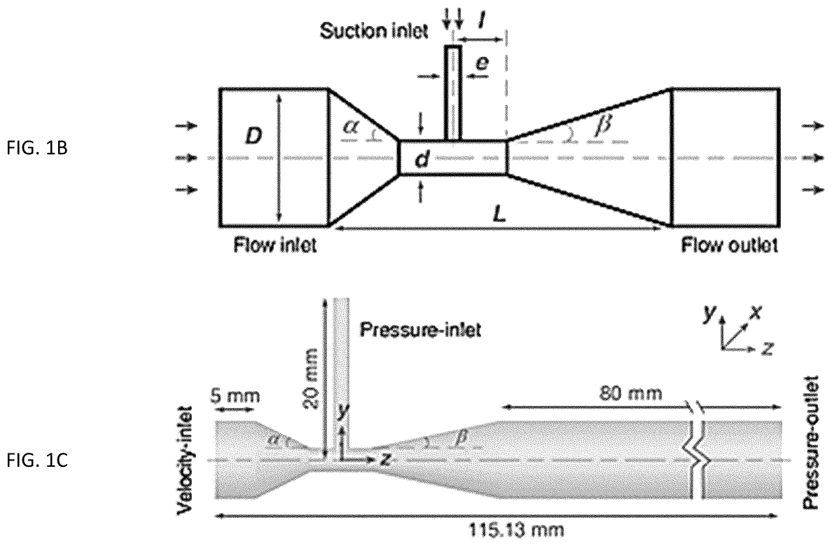

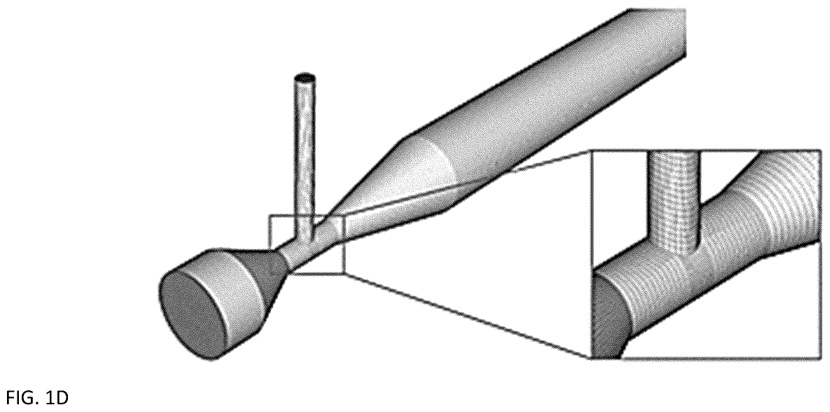

A schematic for preparation of plasma activated water (PAW), is demonstrated in FIG. 1A. The flow loop consists of a plasma nozzle (BD-20AC, ETP, USA), a Venturi tube, a water container (500 mL) and a peristaltic pump (WT600-4F, Longer, China). Plasma nozzle discharged around the spring tip (Model 12201) with a wide output voltage of 10-45 kV and a frequency of 4.5 MHz. The magnitude of electrical discharge could be adjusted via rotating the knob on the top of the plasma jet. In lab-scale experiments, we applied two levels of electrical voltage, namely, the high voltage (around 15 kV) and the low-voltage (around 10 kV), as shown in Table 2. The Venturi tube is used to generate microbubbles by hydrodynamic effect. A thin metal electrode is inserted into a silicon tube (inner diameter=10 mm, length=20 cm) which is linked with the air suction of the Venturi tube. According to Bernoulli's Equation, the local pressure in the throat of the Venturi tube is lower than the ambient pressure, so air is self-suctioned into the tube and is sheared by the fast flow. The aqueous sample is circulated continuously in the closed-loop system. Liquid flow rates of the whole treatment process are controlled by the peristaltic pump within the range of 2.5˜6 L/min. Each group of the experiment is performed for 30 min and repeated three times. Tested samples are collected at an interval of 5 min. In the case of MO degradation, water-transmitting pipes and the water container are covered by the materials with light resistance to prevent degradation by natural light. All the experiments are carried out at room temperature.

TABLE 2
Voltage of discharge and liquid flow
rates applied in the small scale

| Liquid flow rates | | |
|---|---|---|
| (L/min) | Pure water | Tap water |
| High voltage | 2.5, 4, 5, 6 | 2.5, 4, 5, 6 |
| (15 kV) | | |
| Low voltage | 2.5, 4, 5, 6 | 2.5, 4, 5, 6 |
| (10 kV) | | |

In the experiments of dye degradation with large volume, Tube₂ is used as the bubble generator. The liquid flow is driven by a pump (FL-43, Surgeflo, China) at the rate of 17 L/min. The voltage of plasma discharge is 30 kV. The liquid volume of the solution prepared for dye degradation is 17 L that the overall liquid could be possibly circulated once within 1 minute. For the cultivation of soybean sprouts, PAW is produced by activating pure water (1 L) for 30 min under an electrical discharge of 30 kV, and liquid flow rate of 5 L/min. Producing PAW once could be used for two days of cultivation. Four groups of sprouts (12 sprouts/dish) are immersed in PAW for 30 min in the petri dish every day, and then stored in a refrigerator (4° C.) and the external surrounding (25° C.).

### Design and Fabrication of Venturi Tubes

The geometrical designs and parameters of two Venturi tubes that are used in small and large scales are depicted in FIG. 1B and Table 3. Both Venturi tubes have the same inlet and outlet angles, but a few geometrical factors (e.g, D, d, e) of Tube₁ are enlarged to meet the requirements for large-scale treatment. In our previous study [34], the Venturi tube (Tube₁) is used to generate microbubbles under cavitation and air suction conditions. Venturi tubes used in this study are firstly designed by SolidWorks, then fabricated in a machining shop. Polymethyl methacrylate (PMMA) is selected as the material of Venturi tubes due to its good light transmission for optical observation.

Dissolved oxygen (DO) are measured using a multiparameter system (S975-uMix, Mettler Toledo, Switzerland). To avoid cross-contamination, the probe is cleaned by diluted ethanol solution and followed by Milli-Q water between individual tests. The liquid temperature is detected by a digital thermometer (Type K). In each group of experiments, results are obtained from the average values of three repeats.

Table 3-Dimensions of the two Venturi tubes (FIG. 1A) used in our experiments. Tube₁ and Tube₂ are the two Venturi tubes used in small-scale and large-scale treatments, respectively.

TABLE 3
Venturi Tube Dimensions

| Tube | D (mm) | L (mm) | d (mm) | e (mm) | α(°) | β(°) | l (mm) |
|---|---|---|---|---|---|---|---|
| Tube₁ | 9.7 | 30 | 3 | 2 | 26 | 12 | 3.75 |
| Tube₂ | 19 | 57.28 | 5 | 3 | 26 | 12 | 5 |

### Visual Observations of Microbubble Formation

High-speed camera (NOVA S12, Photron, USA) is utilized to follow bubble formation inside the Venturi tube. Bubbling water is circulated in a loop at flow rates of 2.5, 4, 5 and 6 L/min. An LED backlighting with a diffuser is set up to record the process with 1024×1024 pixels resolution at 12800 frames per second.

### Characterization of Plasma Discharge

The emission spectrum generated by the plasma nozzle is qualitatively measured by a set of optical emission spectra (OES). A spectrometer (HR4D1943, Optics Inc., USA) equipped with an optical fiber is linked to a computer, operating in both ultraviolet and visible light from 200 to 900 nm. OES spectra are recorded at a wavelength resolution of 0.271 nm with a total of 5 scans. In order to capture or focus more light emitted from the plasma nozzle, an optical condenser is installed with a distance of 5 cm at the center of the plasma nozzle and one tip of optical fiber. The data process is performed using Ocean View Optics software (OpticsInc., FL, USA). The peaks of the OES spectrum are identified by the databases of the National Institute of Standards and Technology (NIST) and high-resolution transmission molecular absorption (HITRAN).

The surface temperatures of the plasma nozzle and bubbling water are measured by an infrared (IR) camera (L200, Telops, Canada). The pixel resolution opted is 640×512. Vivid infrared images are transmitted immediately from the external camera to software (Revealir) where the transient matrix of temperature data and the temperature variations with treatment time are processed.

As the surface temperature of the plasma nozzle is measured, the tip of the metal electrode is placed on the top of the water surface with a gap of 2 cm. Since the electrical nozzle is very thin, the increase in temperature could be indicated by the color change of the water surface. In the system of bubbling water, the overall change of temperature around the water container in FIG. 1A is tracked by the infrared camera as well.

### Measurements of UV-Vis Spectra

UV-vis spectrum of MO is detected from 190 to 700 nm by using SHIMADZU UV-2700 Spectrophotometer. Dye degradation efficiency with treatment time and degradation rate are calculated in this study as the following relationships.

$$Degradation efficiency ( \% ) = ( {C}_{0} - {C}_{i} ) / {C}_{0} \times 100 \qquad Equation 1$$

$${C}_{i} = {C}_{0} exp ( - kt ) or ln ( {C}_{i} / {C}_{0} ) = - kt \qquad Equation 2$$

where Cᵢ and C₀ are the concentration of dye solution at treatment time t and 0, respectively. k is degradation rate constant [35]. Degradation of MO is calculated from absorption intensity at 464 nm.

### Electron Spin Resonance

Electron spin resonance (ESR) is carried out to detect the free radicals in plasma activated water. DMPO (5,5dimethyl-1-pyrroline-N-oxide) is a nitrone spin trap and is prone to trap hydroxyl and superoxide radicals with the production of stable nitrone spin adducts that can be identified by the ESR spectrometer. ESR data is obtained from an X-band electron spin (paramagnetic) spectrometer (JEOL, JES-FA200). The spectra are recorded with the microwave power of 0.998 mW at the frequency of 9.055 GHZ, modulation frequency of 100 kHz, modulation amplitude (or width) of 0.1 mT, time constant of 0.1 s, magnetic field sweeping rate of 10 mT/min and the accumulation times of 4. The preparation of samples for ESR measurement followed the procedures as shown in FIG. 1A. To accurately prove the existence of reactive species, the concentrations of spin trap reagent employed are 20 mM and 100 mM. 200 mL pure water is used as the aqueous sample for ESR measurements.

### Numerical Simulation

The work of numerical simulation is carried out in the fluent module of ANSYS Workbench software (ANSYS 19.2.0) using the FVM (Finite Volume Method) method. A 3D model is considered and the geometric parameters are based on Tube₁, as sketched in FIG. 1C. This specific physical model consisted of six parts: water inlet (5 mm), convergent section, suction inlet (20 mm), throat, divergent section, and mixture outlet (80 mm). It is positioned horizontally, so that gravity acted along the—y axis.

The working fluids of gas phase and liquid phase used in this study are air and water, respectively. The effect of plasma on composition of the inhaled gas is ignored. Both the water and air are set as incompressible fluids without considering the relative change of gas density. The physical parameters of water and air used are listed in Table 4. For the boundary conditions, the water inlet is specified for velocity-inlet, the suction port within the throat as the pressure-inlet with atmospheric pressure, and the outlet as the pressure-outlet with atmospheric pressure. At the wall the no slip boundary condition is considered. The flow rates of the water injected from the inlet are varied from 2 to 9 L/min, covering the range of flow rates used in the experiment.

TABLE 4
Physical properties of working fluids
used for numerical computations

| | Density | Viscosity | Surface tension |
|---|---|---|---|
| Fluids | (kg/m³) | (Pa · s) | (N/m) |
| Water | 998.16 | 1.003 × 10⁻³ | 0.072 |
| Air | 1.225 | 1.789 × 10⁻⁵ | |

The 3D geometrical model of the Venturi tube constructed by Solidworks software is imported into ANSYS ICEM (embedded in the Workbench) to define the boundary conditions and mesh. The grid layout of the Venturi tube is shown in FIG. 1D. The mesh type of computational domain is O-type hexahedron. After determining the sensitivity to grid refinement and further considering the time consumption, the computational domain is constructed with a node number of 858,840 and the cell number of 836,884, respectively.

For all the cases, the multiphase model of coupled level set and volume of fluid method (CLSVOF) [36, 37], is used to simulate the hydrodynamic characteristics of the multiphase flow and to track the interface between phases in the Venturi tube. Generally, the CLSVOF method can implicitly capture interfaces and is easy to handle deformations of complex interfaces and changes in topology. It improves the tracking resolution than the simple VOF method, and is more suitable to tack moving interface accurately. In each control unit, a set of governing equations that follow mass and momentum conservation are solved to determine the volume fraction of gas or liquid phases [38, 38, 39]. Meanwhile, the turbulent flow is calculated using a realizable k−ε model. The level set method expresses the spread of the gas-liquid interface with a higher order function of zerovalue and hence distinguishes the two phases in the computation domain with this function value [40].

Initially the steady simulations (typically 104 iterations) are carried out without heat and mass transport using pressure-based solver and subsequently the transient simulations (time-step size of 10⁻⁴ s) are activated when the convergence criteria are met. The Coupling scheme is used for Pressure-Velocity Coupling, with the PRESTO! discretization scheme applied for pressure and Second-Order discretization scheme for momentum, respectively. The turbulent equations are also discretized with Second-Order accuracy. The convergence criterion in the calculation for the momentum equation and the continuity equation is 10⁻⁶ and for the k−ε equation is 10⁻⁴

### Results and Discussion

### Integration of Cold Plasma Activation and Microbubble Generation in a Flow System

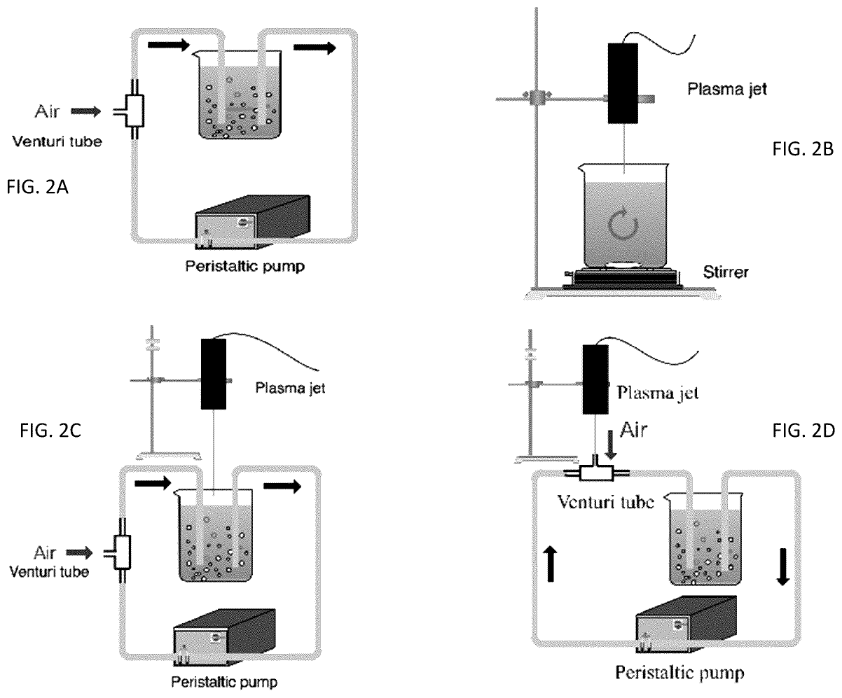

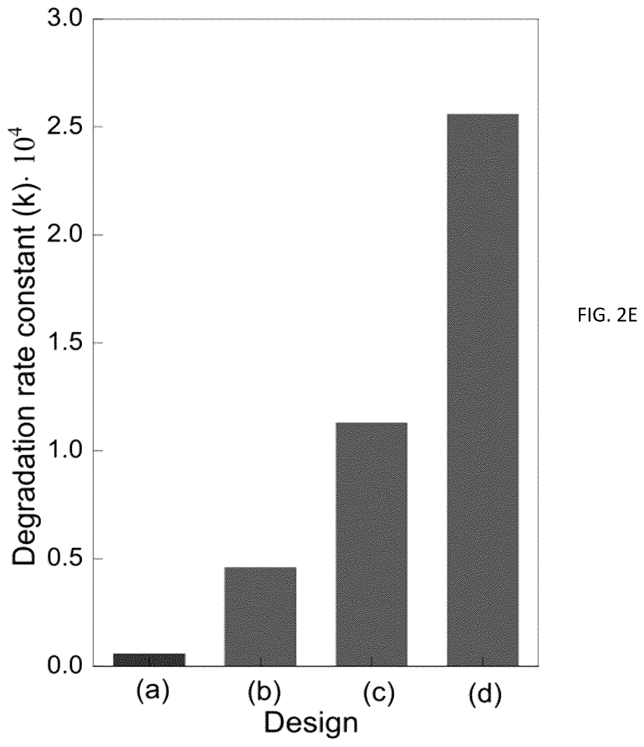

FIGS. 2A-2D illustrate four configurations showing treatment of dye solutions (methyl orange in tap water) and corresponding degradation rates. Under the treatment of FIG. 2A, with sole bubbling treatment, there is no visible color change within 30 min. Similar results are also found in FIG. 2B when the plasma nozzle is applied on the surface of the flowing liquid. Herein, in our study, the sole treatment of plasma or microbubbles can not degrade the dye in water. In contrast, previous work reported that the collapse of microbubbles can produce ·OH in the bulk either via the methods of ultrasonic or hydrodynamic cavitation, which contributes to decompose and mineralize the organic dye, resulting in the color fading of the solution [8, 41].

The plasma nozzle is placed above the surface of the liquid sample and inside the air suction part as depicted in FIGS. 2C and 2D, respectively. After treatments, a strongest degradation phenomenon is observed in FIG. 2D, showing a highest degradation rate and a 5-time higher rate than the setup without microbubbles in FIG. 2B. Gaseous plasma is generated by air ionization, sucked into the Venturi tube and then trapped in bulk microbubbles.

Bubbles provide large surface area for the gas-liquid interaction. Meanwhile, the dissolution of bubbles in the bulk enhances the mass transfer of reactive species. The efficient exchange from gaseous to aqueous phases achieves the highest degradation rate. Components transferred through the gas-liquid interface include O, H, O₃, NO, O⁻₂, H₂O₂ and HNOₓ to name just a few [42]. Overall process covers the gas and liquid phases chemistry, mass and heat transfer and interfacial reactions. Penetration depth of species depends on their lifetime. This group of results show that plasma treatment assisted with microbubbles is the most efficient approach to remove the dye pollutants from the liquid, which is strongly agreed with the previous work [43]. In the following experiments of this study, design (d) is implemented as a combined treatment method on degradation process.

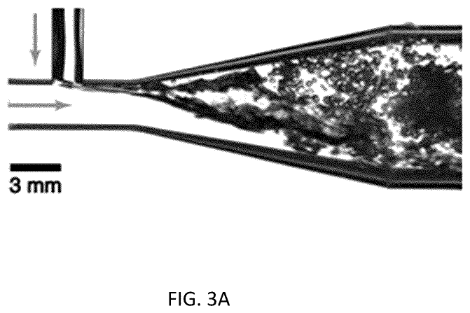

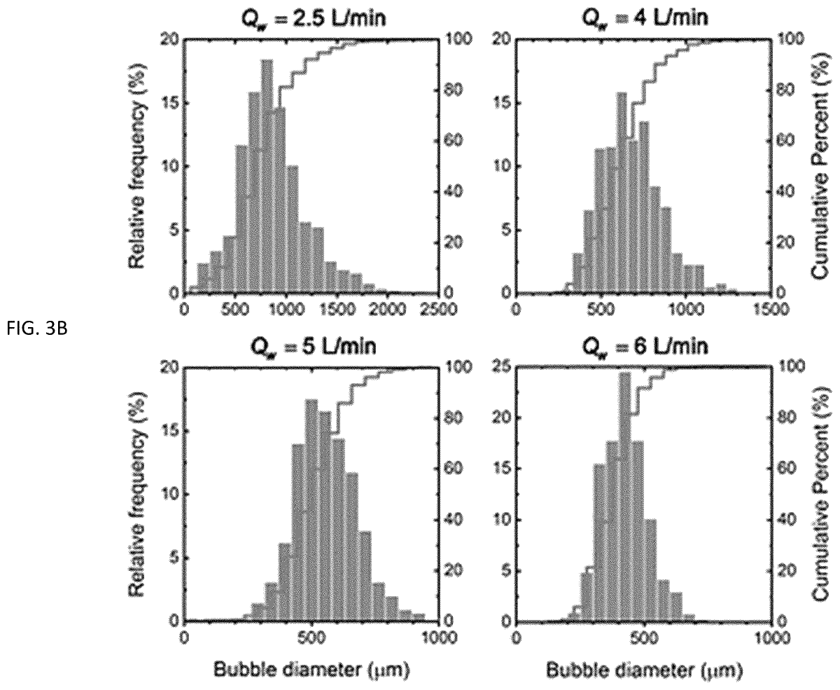

Bubble transportation and dynamic performance are observed in the diverging region of the Venturi tube. FIG. 3A shows a snapshot of the gas-liquid two-phase flow in the Venturi tube₁ with the water flow rate of 5 L/min. After the air is sucked and sheared by the passing liquid flow with high velocity, the bubbles with a wide range of size are generated and traveled as a cloudy structure. A gaseous jet stream is clearly observed at the throat and divergent section of the tube with the background water. Instead of flowing directly downstream, these generated bubbles passively enter a large vortex that rotates counterclockwise in this region.

To obtain quantitative information on the bubbly gas-liquid flow, we obtain the size probability distribution of the generated bubbles in the straight section of the channel by image processing, as shown in FIG. 3B. Four cases with various water flow rates ranging from 2.5 to 6 L/min are given. Increasing the water flow rate Q_{w} results in a smaller mean bubble size and a narrower bandwidth in size distribution. When Q_{w}=6 L/min, the mean diameter of the generated bubbles is only about 400 μm. Meanwhile, although not shown quantitatively, we also found that the number of bubbles produced also increased significantly with the water flow rate. Overall, reactive species generated by plasma sustained in bulk bubbles are responsible for MO degradation. Complex behaviors of bubbles provide reactive species with high mass transfer efficiency from the gas to the liquid phases. Therefore, it is reasonable to conclude that the Venturi tube provides a desirable environment for dye degradation.

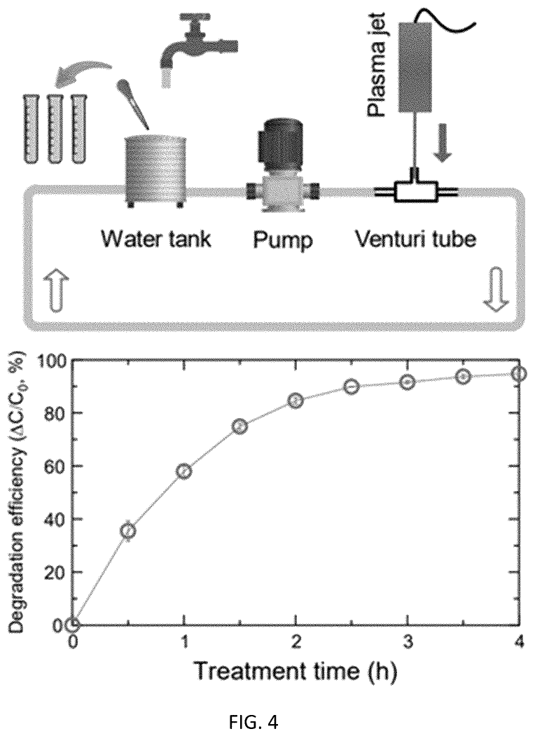

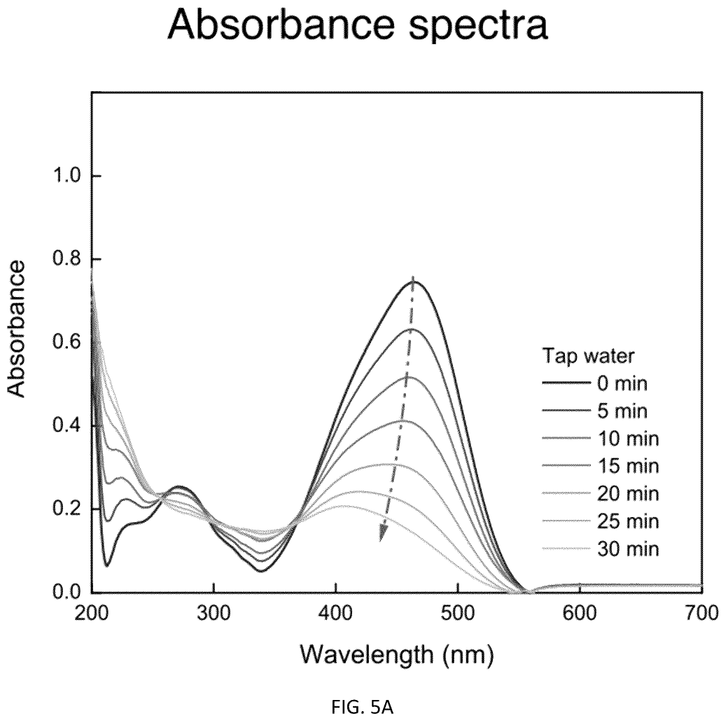

To confirm the feasibility of quality of microbubble enhanced PAW, the degradation efficiency at a large scale (see FIG. 4) and effects of PAW on sprouts quality (see Supplementary file) are assessed. 17 L of tap water is used as the medium of dye solution. 84.6% of methyl orange is removed after 2 h treatment. After 4 h, the degradation efficiency reached above 95%. Results from large scale prove that this novel design of combined treatment can be effectively used in large-volume water treatment, especially for dye decolorization. To identify the efficacy of this setup, previous works on the same dyestuff degradation by plasma are also listed in Table 5. The degradation efficiency is lower at the larger scale because the free radicals in PAW are diluted more. Our microbubble-enhanced activation can treat more water in much shorter time with similar degradation efficiency. The promotion of treatment efficiency and capacity can be achieved by optimizing and expanding the size of devices. Thus this designed reactor has great potential to be used in industrial water treatment.

TABLE 5
Comparison of several plasma systems applied for MO degradation

| Ref. | Initial solution | | Type of plasma treatment | Operation conditions | Feed gas | Removal efficiency |
|---|---|---|---|---|---|---|
| This study | 17 L | (10 mg/L)^{a} | Corona discharge & | 30 kV, 41.4 W | Air | 84.6% after 120 min |
| | 500 mL | (10 mg/L)^{b} | Venturi bubble generator | 15 kV, 41.4 W | | 90% after 10 min |
| [44] | 450 mL | (10 mg/L) | Water surface plasma | 22 kV, 50 Hz | Air | 90% after 15 min |
| [15] | 100 mL | (10 mg/L) | Plate discharge in air above | 40 kV, 0.6 W | Air | 90% after 15 min |
| | | | water surface | | | |
| [45] | 3 L | (4.33 × 10⁻² mM) | Plasma & Dissolved oxygen | Applied voltage: | O₂ | 26% after 80 min |
| | | | generator | 230-250 V, 25-30 kHz | (50 ppm) | |
| [7] | 300 mL | (10 mg/L) | Needle-plate electrode | 20 kV, 25 Hz | N/A | 90% after 100 min |
| | | | spark-streamer mode | | | |
| [46] | ~100 mL | (200 mg/L) | ID-APPJ^{c} | 0.7 kV, 0.2 W | Ar | 92% after 30 min |
| | | | D-APPJ | 1.2 kV, 0.4 W | | 99% after 30 min |

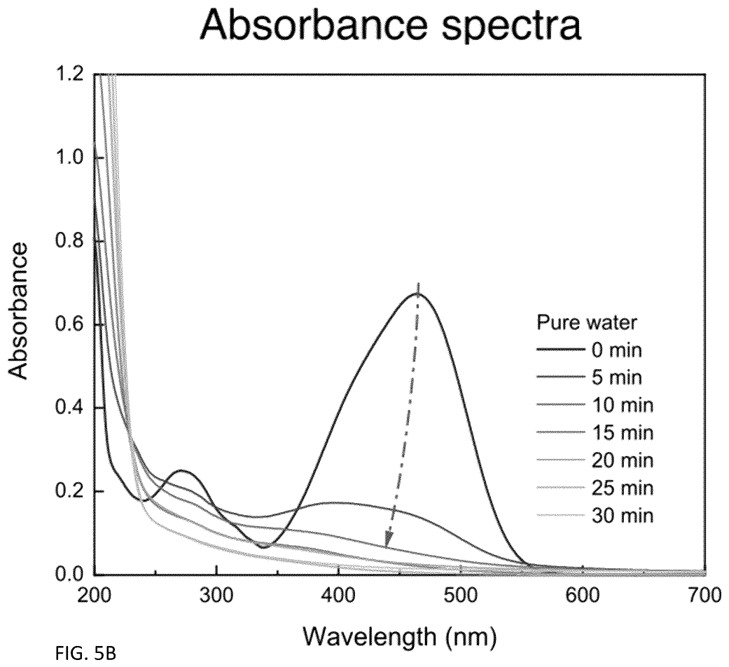

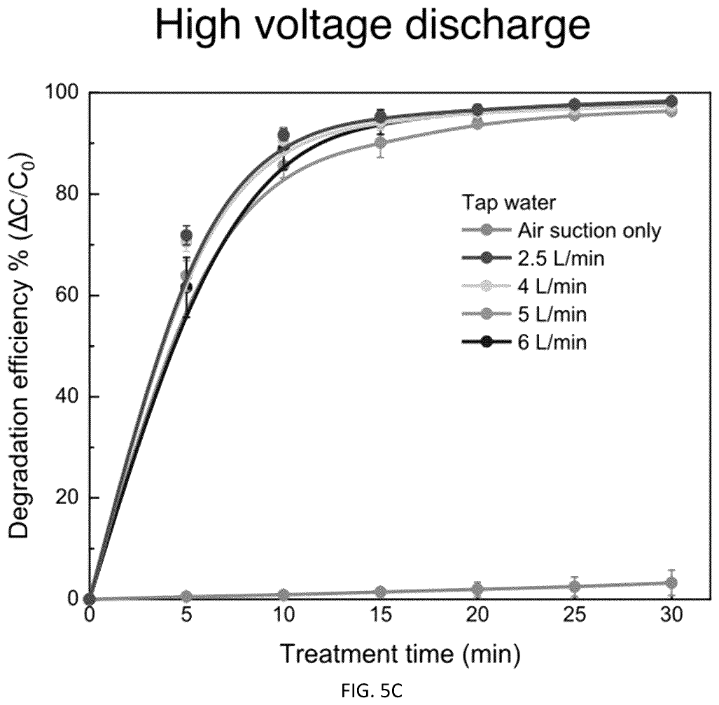

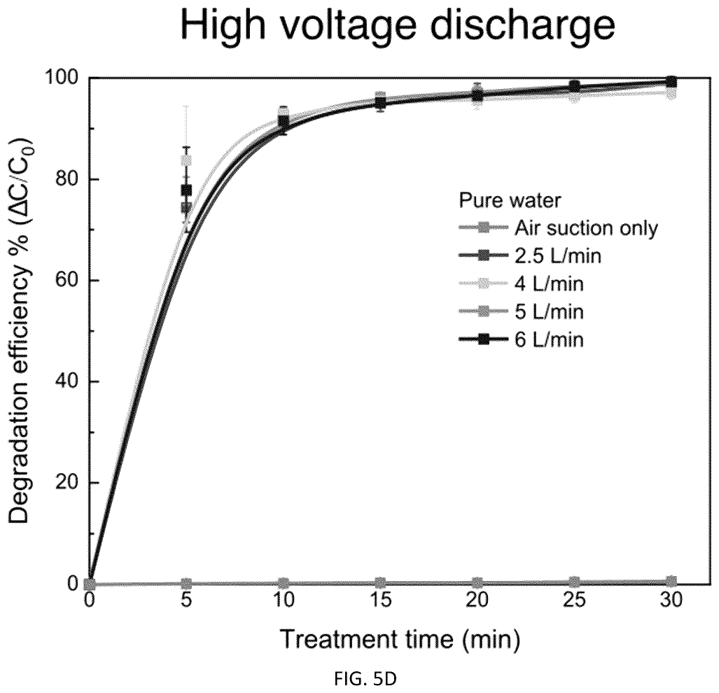

^{a}The data is selected from FIG. 4.
^{b}The data is selected from FIG. 5D.
^{c}ID-APPJ and D-APPJ mean indirect-atmospheric pressure plasma jet and direct-atmospheric pressure plasma jet, respectively.

### Evaluation on Dye Degradation Efficiency

Lots of works have already investigated the mechanism and efficiency of dye degradation, while their experimental designs or conditions for treatment have some differences [2, 15]. In previous works, pure water is commonly used for studying the dye degradation as water background, but few studies worked on the tap water system since the aqueous surrounding is considerably complicated. Besides, effluents from wastewater treatment plants and dyes workshops are commonly on the basis of tap water. Therefore, in order to cover all the parameters affecting the water treatment process, current study focuses on dye degradation both in tap water and pure water.

Absorbance spectra of the liquid solution prepared in tap water and pure water are shown in FIGS. 5A and 5B, respectively. With the same treatment for (a) and (b), both degradation spectra and snapshots of solutions show that MO removal in pure water is more efficient than in tap water. The time course of degradation efficiency of methyl orange solution (tap water-prepared) with and without plasma treatment at high voltage with air microbubbles is demonstrated in FIG. 5C. The sole addition of air microbubbles had little effect on the decolorization of MO as shown in the blue line, reaching a decolorization efficiency of approximately 3.24% after 30 min. This observation agrees with the previous work [47]. Although the sharp collapse of bubbles accelerated the formation of ·OH, quantities of these free radicals are too low to be potentially used for dye decomposition [48]. However, it can be clearly seen that the degradation efficiency of MO significantly increased with the participation of plasma, especially within the first 10 min. After 15 min, the degradation of MO reached about 95.24%. It indicates that plasma is essential for the decolorization of MO solution. Meanwhile, it shows the higher liquid flow rate did not cause the significant enhancement in degradation efficiency at high power input. At the low case (FIG. 5E), the lower electric field intensity could consequently generate less reactive species, which strongly agrees with the previous work [44]. For example, there is 91.46% decolorization efficiency at the flow rate of 6 L/min, and 49.79% decolorization efficiency at 2.5 L/min after 30 min plasma discharge. The higher the flow rate, the better performance in dye removal was. This is mainly because the values of bubble size and number are remarkably influenced by the flow rate of liquid, resulting in different situations in which the reactive species are involved in the system. It also appears that the effect of electrical voltage is much greater than the effect of liquid flow rate.

Similarly, a time-series evolution of degradation efficiency of MO prepared by pure water at high and low voltage discharge is illustrated in FIGS. 5D and 5F, respectively. There is not any decolorization without the presence of plasma. Pure case shows the higher removal efficiency than that in tap water. For example, the removal efficiency is achieved about 80% after 5 min treatment in the group of pure water while it required 8-9 min to meet the same level in tap water. In groups of low discharge (f), at a maximal flow rate of 6 L/min, it took 10 min to achieve 90% removal at high discharge while 30 min at low discharge. Compared to the results in tap water and in pure water, repeatability of the pure water group performs better than that of tap water. On the one hand, impurities in tap water may possibly participate in the chemical reactions in the degradation process and inhibit the overall degradation efficiency. On the other hand, we found that the pH variations between tap water and pure water behave in opposite trends, approximately performing some differentials on efficiency.

### Physicochemical Properties of PAW

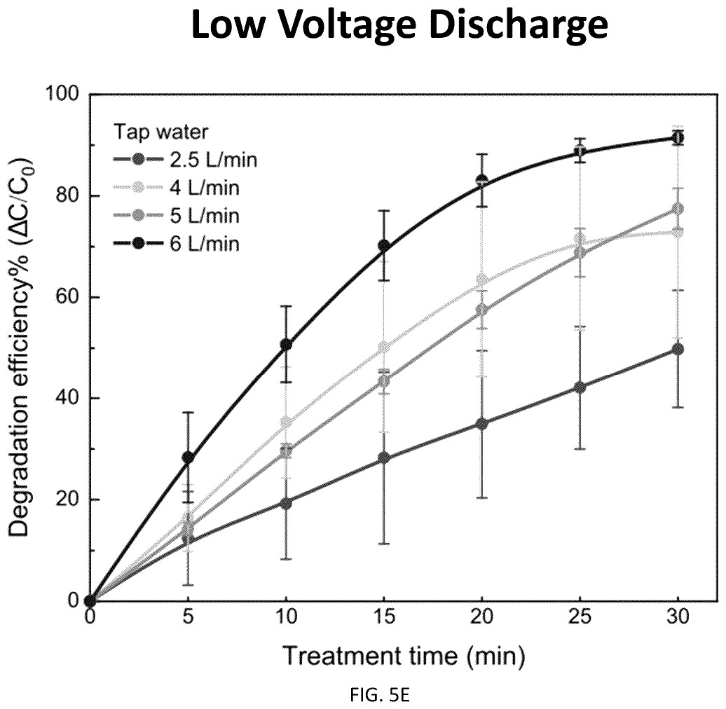

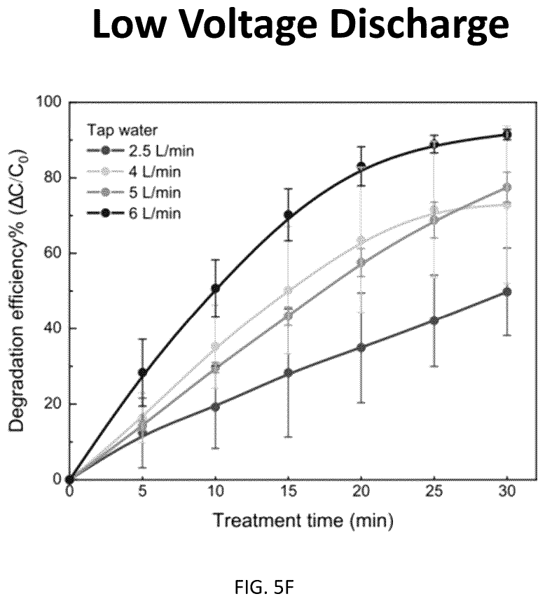

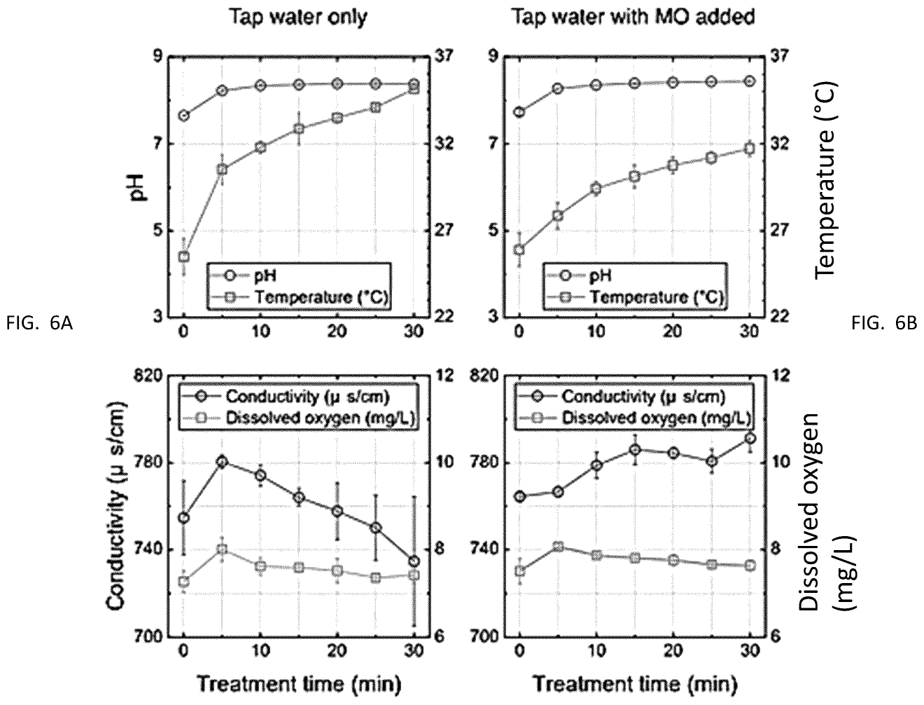

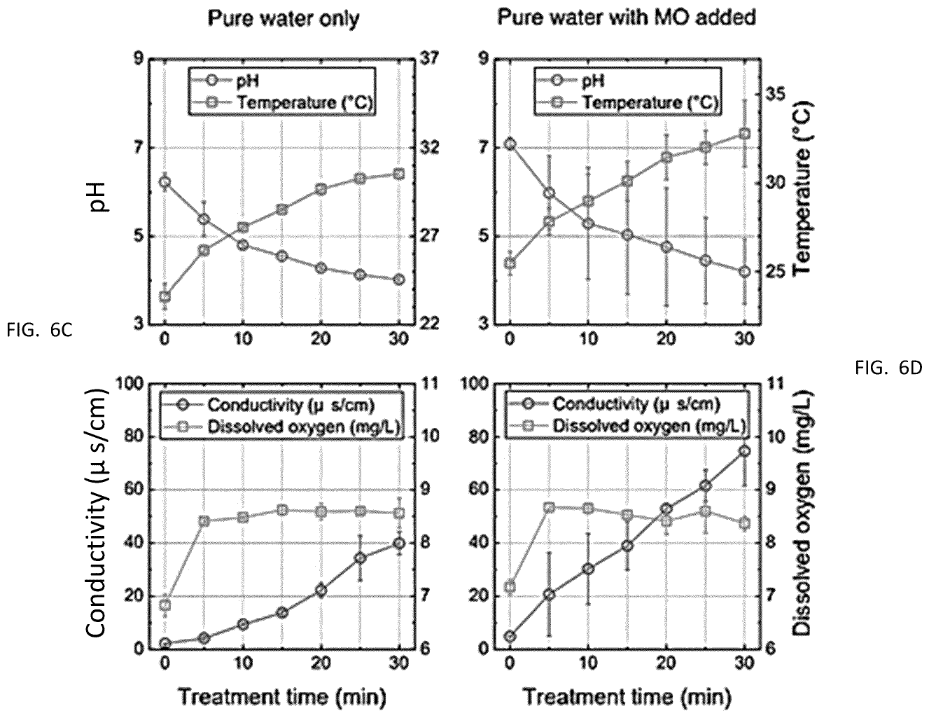

Several fundamental characteristics of collected samples during the combined treatment are measured, including pH, dissolved oxygen and conductivity. Effects of combined treatment on these variables in tap water groups with the function of treatment time are illustrated in FIGS. 6A and 6B. In both solutions, with treatment, values of pH increased slightly at the beginning of the treatment. Tap water and MO solution herein performed alkaline surroundings after combined treatment.

In terms of conductivity of the liquid, it raised slightly, then dropped obviously in tap water. From a chemical point of view, tap water contains large amount of substances, for example, Ca²⁺, Na⁺, Mg²⁺, SO⁻⁴, HCO⁻₃, CaCO₃ hardness and others [49]. These soluble ions make the conductivity of tap water higher than that of pure water. Meanwhile, plasma treatment is capable of removing bicarbonate ions (HCO⁻) in produced water, which is a new non-chemical fouling prevention method [50]. A previous work found that the concentration of Ca²⁺ in tap water dropped by 20-26% after direct plasma treatment, compared with no-drop in untreated cases. Plasma treatment can induce calcium carbonate precipitation (small and crystallized calcite). In reality, precipitation and dissociation reactions are much more complicated. It is hypothesized that this process possibly related to electrolysis and formation of reactive species, shock waves and local heating produced by plasma technology [51]. The decrease of calcium in the tap water-treated group can explain why the value of conductivity decreases with plasma treatment in tap water. Meanwhile, we expected that some HCO⁻ ions are consumed and form OH⁻ and carbon dioxide, as shown in Reaction 3, which helps the aqueous keep a slight alkaline surrounding in tap water case. For the mixture, conductivity shows an increasing trend from 764 μs/cm to 791 μs/cm. This continuous increase may be related to the formation of soluble ions in PAW originated from plasma discharge and the degradation process. For dissolved oxygen, the formation of bubbles enhances the level of dissolved oxygen at first 5 min in both cases. Then this value kept stable due to the over-saturation of gas solubility in the bulk.

$${HCO}_{3 ( a q )}^{-} ⇔ {OH}_{( a q )}^{-} + {CO}_{2 ( a q )} \qquad Equation 3$$

The characteristics in pure water alone and its MO mixture are shown in FIGS. 6C and 6D. The values of pH in both liquids decreased significantly. Such as, pH values decreased from 7.09 to 4.2 in case of MO solution. In pure water, pH decreased from 6.23 to 4.02, which is consistent with other studies [52]. They found that pH of deionized water decreased from 6.45 to 3.11 after 20 min of treatment, with the appearance of nitrite and nitrate for high decontamination. Also, if the pH of the solution reaches values lower than 3, it prefers to form peroxynitrous (ONOOH) acid in the bulk [52]. It has been reported that the concentration of dissolved ozone increases with the decrease of pH. Direct oxidation by ozone has been considered the most important mechanism for the decomposition of organic pollutants in acidic solution [53]. The opposite trends of pH in tap water and pure water can potentially explain why MO solution prepared by pure water shows a better degradation efficiency. As the findings from [47], acidic conditions benefit the decolorization process, resulting in a higher degradation ratio [47]. Same with the group in tap water, the combined treatment also increased the temperature of liquid after 30 min treatment in the group of pure water.

In terms of conductivity, both values increased with activation time due to the formation of ions in PAW caused by the continuous suction of ionized gas into the aqueous system. Meanwhile, air sucked into water increases the contact areas of gas-water, thereby increasing the value of dissolved oxygen. Then it kept stable at around 8.6 with the following circulation. Dissolved oxygen in pure water is higher than that in tap water. An optimum level of dissolved oxygen can produce more OH radicals and results in a higher degradation rate of methyl orange, especially at 50 ppm DO concentration in their system [45].

The differences in decomposition efficiency of the methyl orange in pure and tap water result from pH and cosolutes in the solution. The lower pH in pure water and complex chemical environment in tap water make the degradation efficiency in the purer case higher.

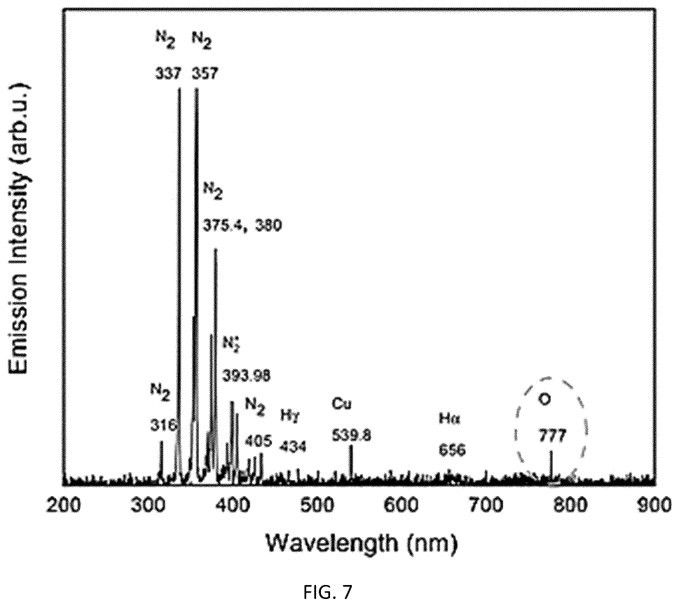

OES is employed to characterize the main reactive species generated by the air plasma ranging from 200 to 900 nm. As shown in FIG. 7, the emission spectrum is dominated by oxygen and nitrogen emission lines because of the plasma discharge in external air. The atomic oxygen spectrum at 777 nm is possibly due to the transition of O (3p5P→3s5S) [54]. The appearance of the copper spectrum line might be due to the material of the electrical electrode, which is made up of copper-nickel alloys.

OES results indicate that excited atomic oxygen and nitrogen are the main products of air plasma discharge. In the experimental treatment, these reactive species are generated by gaseous ionization and trapped as the form of bulk bubbles. Dynamic interaction at gas-liquid interface helps transfer reactive species into liquid, thereby converting to RONSs in the aqueous phase, for example, hydroxyl radicals (·OH), singlet oxygen (¹O₂), superoxide (O⁻₂), hydrogen peroxide (H₂O₂), ozone (O₃), nitric oxide radical (NO·), nitric oxide (NOₓ), peroxynitrite (ONOO⁻) and other components [55].

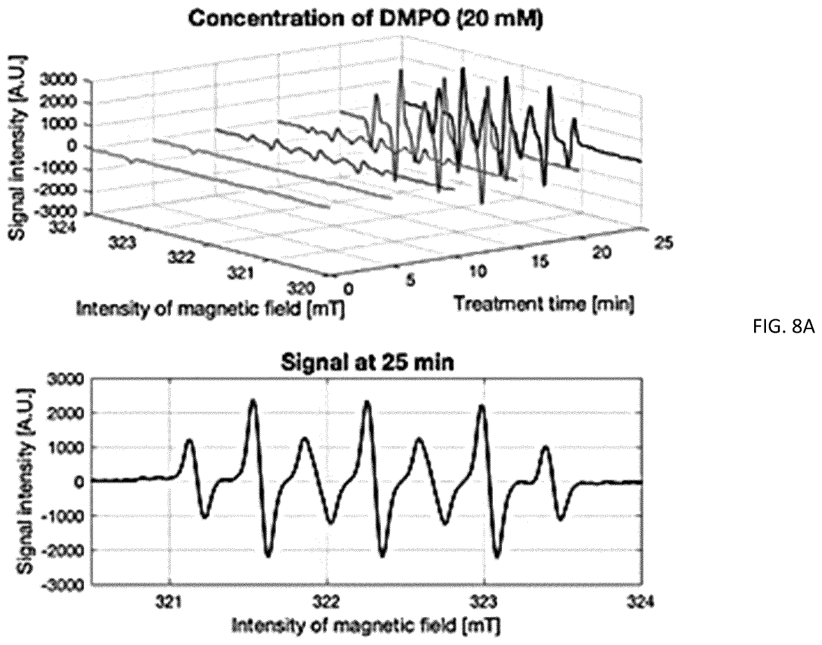

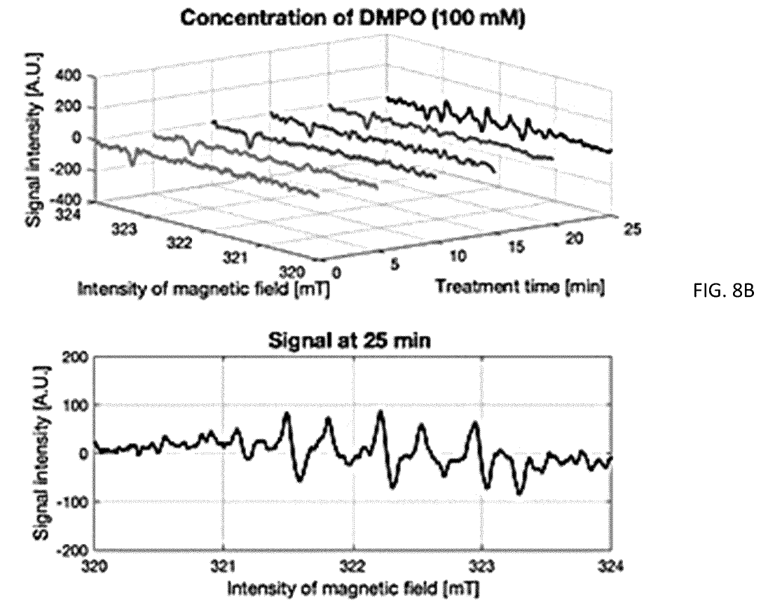

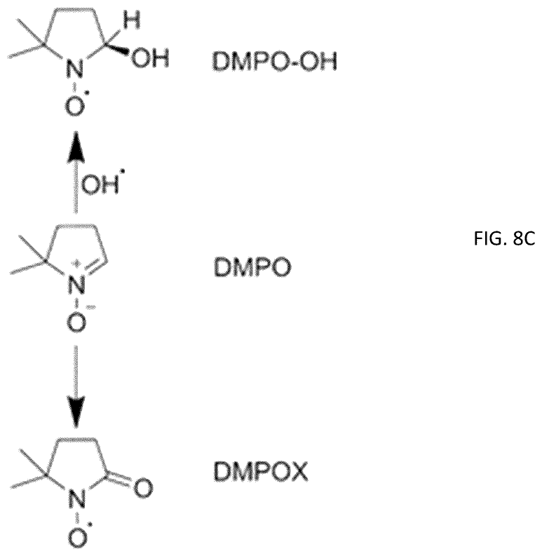

Hydroxyl free radical is one the most essential species with the highest redox potential (2.84 eV). A spin trap DMPO is used to test the production of ·OH in plasma activated water. DMPO reacts with ·OH. The product paramagnetic compound of DMPO-OH (2-hydroxy-5,5-dimethyl-1pyrrolidinyloxy) shows the four-peak spectrum with an intensity ratio of 1:2:2:1 [S6]. In our ESR results, as shown in FIG. 8A, a seven-peak spectrum is observed rather than the standard four-peak spectrum of DMPO-OH as we expected. The spectrum consists of a nitrogen triplet, and each line is divided into triplets in a 1:2:1 pattern.

Based on the information provided from other literature [57-59], a compound in PAW oxidizes DMPO to form DMPOX (5,5-dimethyl-2-pyrrolidone-N-oxyl). The chemical structures of DMPO, DMPO-OH and DMPOX are shown in FIG. 8C. The difference between DMPO-OH and DMPOX is that the group of OH is replaced by an oxygen atom. Differences in the chemical structure of DMPO-OH and DMPOX determine the different spectra obtained. Meanwhile, long circulation time facilitated the production of DMPOX with strong signals.

The results in FIG. 8B show that the signal of DMPOX is weaker and noisier at the DMPO concentration of 100 mM. As reported in literature [60], with the increase of concentration of spin trap DMPO from 1 mM to 10 mM, the concentration of DMPOX increased as a nonlinear relationship within 30 seconds of air plasma activation. However, if the concentration of DMPO exceeds 10 mM, the concentration of DMPOX is reduced with the concentration of DMPO. In other words, the excess of DMPO can inhibit the generation of DMPOX. The weak signal of DMPOX can be explained by the dimerization of DMPOX at higher concentration [60].

We found that the oxidation product of DMPOX is consistent with the literature [57, 59, 60]. The spectrum of DMPO-OH or the trapping process of OH radicals is not observed possibly because the probability of DMPO oxidation is much higher than the process of trapping a primary radical. This whole DMPO oxidation process can be determined by a few parameters, such as the formation rate and decay of trapped free radicals, the rate of DMPO oxidation and the stability of adduct (DMPOX) [57, 58]. Therefore, the presence of the oxidation process proves the solution treated by air plasma shows a high relatively oxidative property.

### Surface Temperature of Plasma Nozzle and PAW

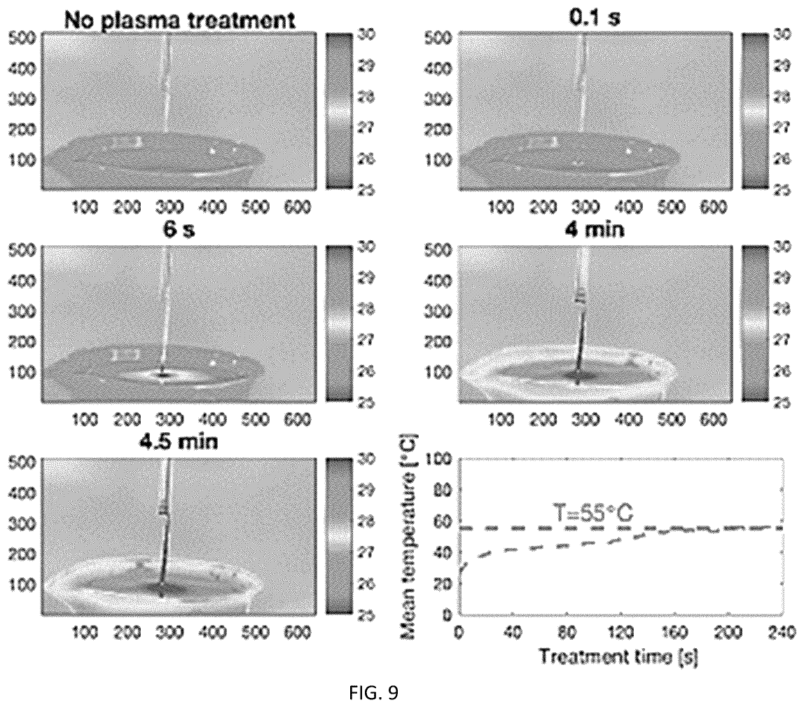

To investigate the variation of temperature in this combined design during the running of the treatment, both surface temperatures around plasma discharge and of bubbling liquid are measured as shown in FIG. 9A. As the metal electrode is initiated, the temperature of the discharge pointer increased instantly and reached a plateau for about 55° C. after 6 min. Thermal images show that the release of plasma causes the increased temperature of liquid underneath the electrode, but the temperature is not too high. It proves that the plasma we applied is the cold plasma in this study.

In a loop system, both the transfer of warm plasma and the driving/friction force from the peristaltic pump contributed to increasing the aqueous temperature. Moreover, the floated bubbles could be visualized on the surface of the liquid in the container, but the infrared camera could not differentiate bubbles from the bulk water via temperature detection.

The bulk temperature increases with activation time, which is consistent with the surface temperature. For example, the temperature of tap water increased from 25.5° C. to 35.15° C. after 30 min treatment. The previous findings showed that the temperature of tap water after plasma treatment by DBD device increased from 27° C. to 36.15° C. after 30 min treatment in a nonlinear relationship [61]. The highest temperature is found at the tip. The surface temperature of the central metal electrode is kept around 55° C., and as plasma discharge initiated, the temperature of bubbling water increased within 30 min, and the liquid flow rate applied is 5 L/min.

### Hydrodynamic Characteristics of the Multiphase Flow

More quantitative insight is gained from numerically modeling the bubbly two-phase flow dependent on self-suction of air. Unless otherwise specified, the results presented in the rest of this section are all from numerical simulation. Gas-liquid two-phase flow is numerically simulated in a full 3D model. For simulation cases, only the water flow rate Q_{w} is varied, from 2 L/min to 9 L/min, covering the range of that used in experiments.

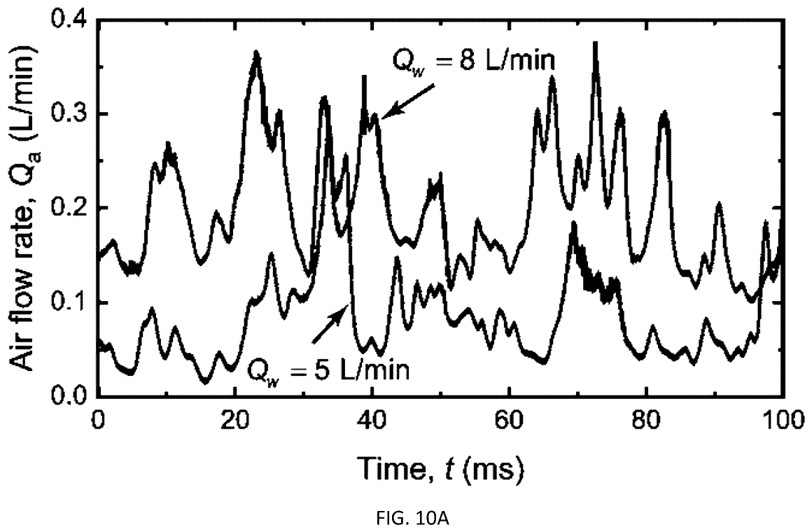

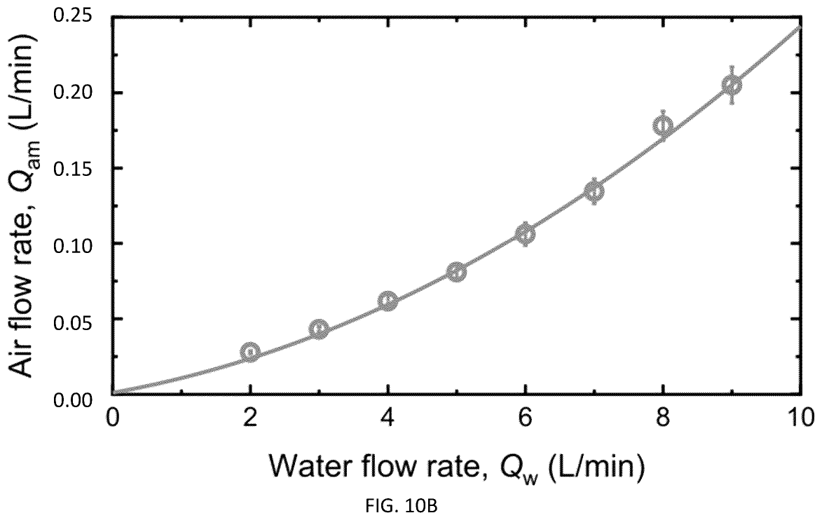

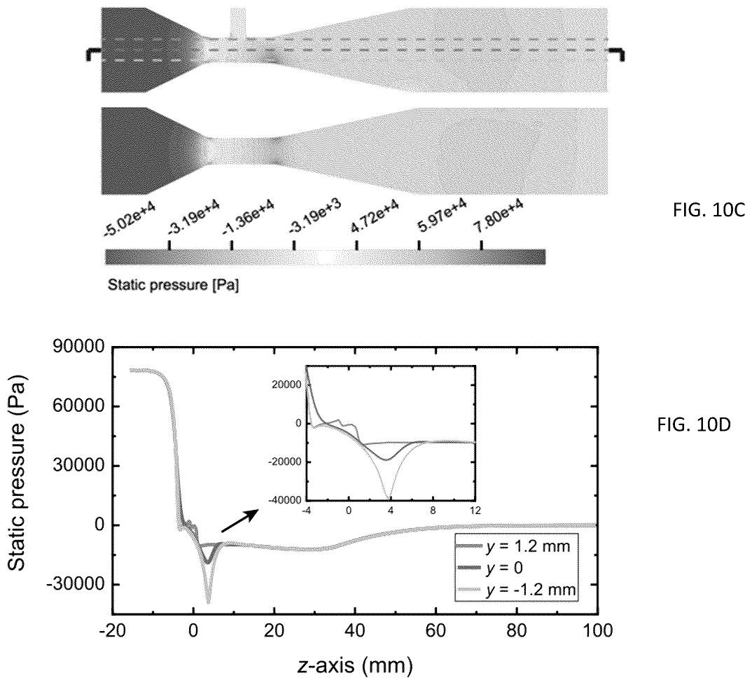

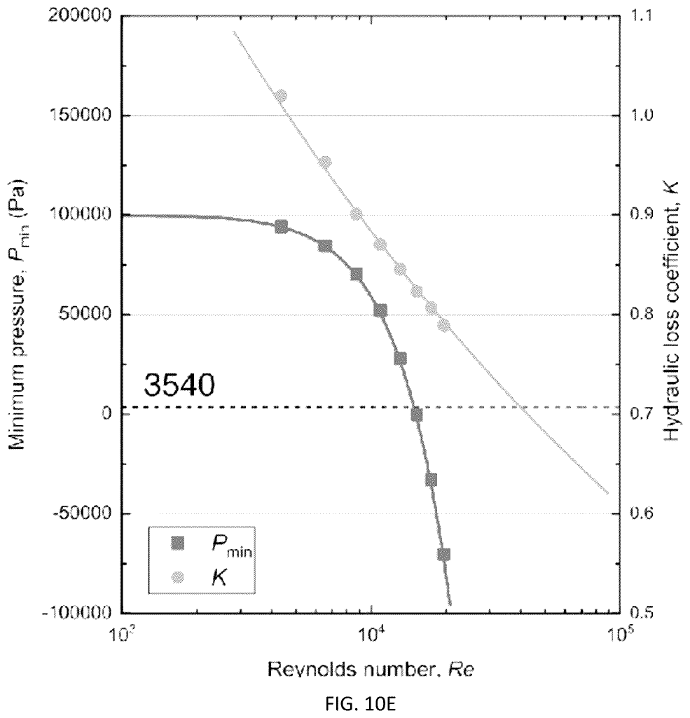

In FIG. 10A, we monitored the volume flow rate of air Q_{α} at the outlet during the operation of Venturi tube for two cases of Q_{w}=5 L/min and Q_{w}=8 L/min. As expected, both Q_{α} oscillate irregularly over a wide range in time. However, typically, a large fluctuation period can be recognized: for Q_{w}=5 L/min, T≈35 ms, and, for Q_{w}=8 L/min, T≈50 ms. We then calculated the mean air flow be expected to be induced by a modification in the pressure difference between the air-inlet and throat. According to Bernoulli equation, the square of flow rate is proportional to the pressure difference. FIG. 10C illustrates the simulated static pressure field in the Venturi channel (the rest of the outlet pipeline is not shown). Given the non-asymmetry of the model, the sliced views both in the y-z plane and xz plane are shown. Correspondingly, the axial profiles of pressure at three y-axis positions (y=−1.2 mm, y=0 and y=1.2 mm) in the y-z plane, are shown in FIG. 10D. Overall, the static pressure experienced intensive changes near the outlet of the converging section and the entrance of the divergent section. This is due to the energy loss caused by flow contraction and expansion, and the wall friction. Nevertheless, the presence of openings inevitably leads to complex changes in pressure distribution at the throat, as shown in the inset of FIG. 10D. The pressure distribution shows significant difference only within the throat region, while the three curves are almost overlapping in the rest of the region. Near the opening, the curve of pressure at y=1.2 mm is relatively flat from 0 to about 30 mm (z-axis), because the pressure reduction in this area is not significant. A low-pressure region is formed around the sharp edge of the throat. The nadir of pressure occurs at the bottom of the junction between the throat and diverging section. This is where cavitation first occurs.

Without a doubt, the cavitating flow affects both the hydrodynamic and mass transfer performances of the system. It also would be interesting to reveal this dependency quantitatively in a systematic study. However, in this paper, we focus on the critical conditions for transition rather than the details of fluid mechanics. We can numerically predict whether cavitation will occur depending on whether the minimum pressure Pₘᵢₙ reaches the saturation vapor pressure (typically, 3540 Pa). FIG. 10E shows Pₘᵢₙ as a function of Re (the left y-axis), which is expressed as Equation 4.

$$Re = \frac{{ρ}_{w} {U}_{w} D}{{μ}_{w}} . \qquad Equation 4$$

We see that increasing Re causes a decrease in Pₘᵢₙ at all scales, especially at high Re numbers. Cavitation inception is highly dependent on the details of the local flow gradients within the system (see FIG. 10C). When Re>˜ 14869 (Q_{w}>˜6.8 L/min), cavitation occurs at the bottom of the junction between the throat and diverging section. In general, the effect of cavitation on energy dissipation can be estimated typically using the hydraulic loss coefficient K, which is defined as follows by Equitation 5:

$$K = \frac{2 ( {P}_{in} - {P}_{out} )}{{{ρ}_{w} ( {CU}_{th} )}^{2}} , \qquad Equation 5$$

where Pᵢₙ is the static upstream pressure at the inlet, Pₒᵤₜ is the downstream pressure at the outlet, C=1 is a constant for Venturi tube [63], and Uₜₕ is the mean velocity within the throat section. FIG. 10E shows the hydraulic loss coefficient K as a function of the inlet Reynolds number Re. Increasing the inlet Reynolds number Re typically reduces the hydraulic loss coefficient K. There is a power law relationship in Re—K coordinates for the parameter ranges studied. It is worth noting that, here K<1 does not mean cavitation occurs. For the current system with opening, the cavitation criterion is found to be K<0.83, which is different from the conventional Venturi system.

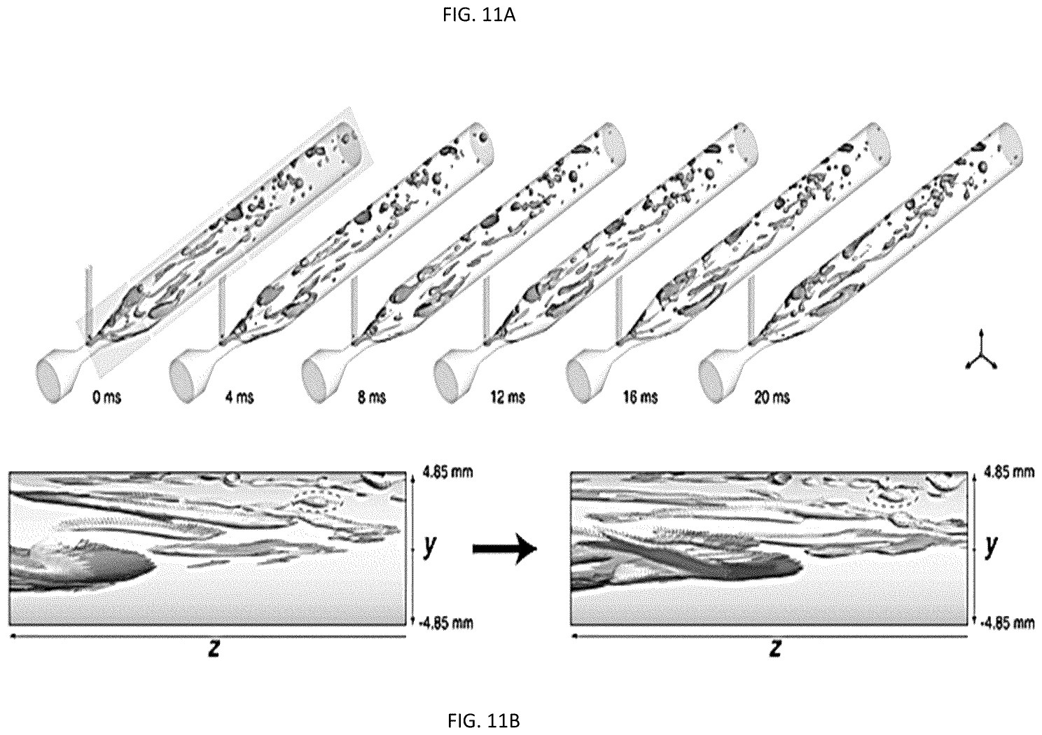

FIGS. 11A and 11B show the flow structure, including bubble motion, deformation, and breakup behaviors at each specific moment. The isosurface of air volume fraction of 0.25 is employed to extract these bubbles. Typically, after the air is sucked in from the throat, three flow zones can be clearly recognized along the flow direction in this Venturi tube, as: shearing-flow zone (marked by orange), recirculation/vortex zone (marked by blue) and small-bubble zone (marked by green). In the shearing flow zone, the continuous gas flow is broken and lots of bubbles are hence generated under the action of viscous shear stress. These bubbles then join the bubbly flow in the divergent section. Considering that the opening port is located at the top of the throat, they generally move along a route away from the center of the tube. In the recirculation zone, the strong turbulent vortex forces bubbles to move counterclockwise so that they cannot flow out directly. As a consequence, these bubbles would undergo intensive deformation, stretching and even collapse into tiny ones under the strong interfacial instability. It is worth noting that, for the current design of the Venturi channel, the recirculation zone plays the most important role in generating fine bubbles efficiently. Typically, the fragmented bubbles can escape from this region and then enter the small-bubble zone.

FIG. 11B shows two instantaneous snapshots of gas-liquid interface when bubble fragmentation occurs. The velocity vectors around the bubbles are also added. We found that, near the boundary of the vortex region, the dispersed bubble is stretched with several slender necks formed under the action of the multidirectional velocity gradient. These slender necks become thinner and thinner and eventually break up into tiny bubbles that flow downstream along the top of the tube. The fluid in the local region of the flow would have actually moved in the opposite direction to the bulk flow.

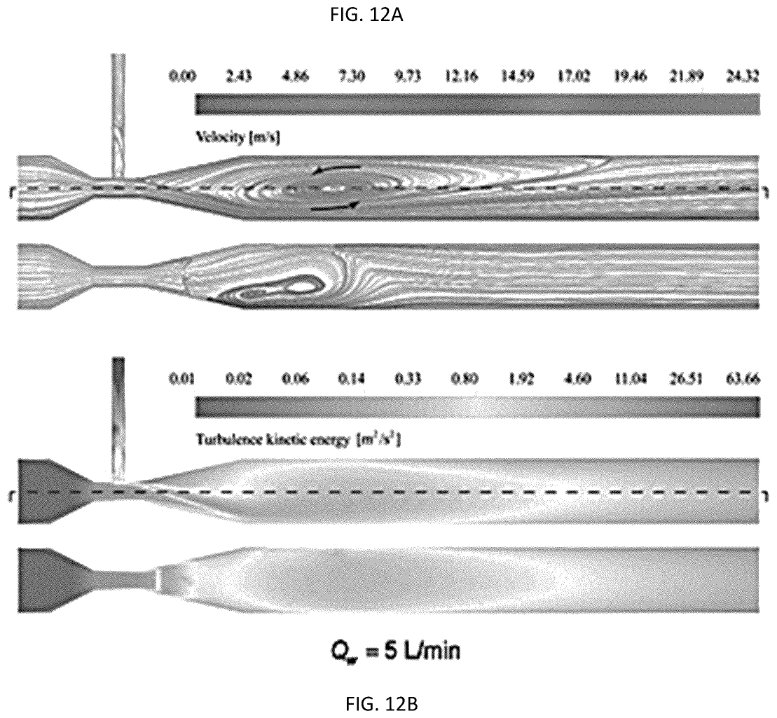

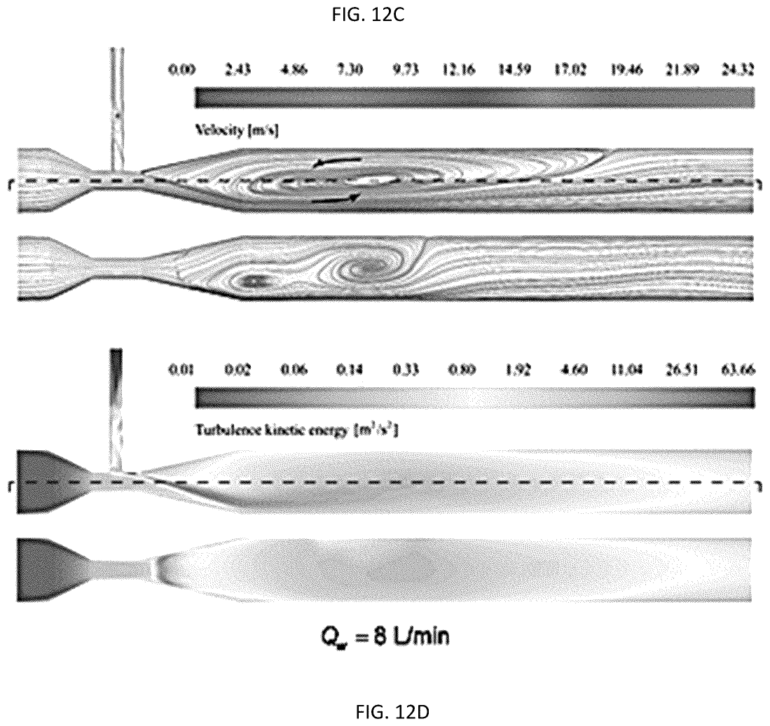

Next, we show the overall flow characteristics in the Venturi channel. In FIGS. 12A-12D, the velocity profile and contours of turbulence kinetic energy in vertical section (top) and cross section (bottom) for two cases are given. The results are obtained after the system has reached a statistically steady state. Apparently, an asymmetric flow means the flow bifurcation and the presence of recirculation zone in the divergent section. It is apparent that this large-scale vortex (˜70 mm long) occupies most of the divergent section and straight section and plays a primary role to determine the hydrodynamic performance. In this study, the presence of recirculating zone traps the bubbles therein, allowing the bubbly flow to fully develop, which in turn leads to smaller bubbles. The vortex can expand and flatten as Q_{w} increases and accordingly, its core is also shifted away from the Venturi tube, as shown in FIGS. 12A and 12C. The variation in velocity occurs typically in the lower sidewall region of the divergent section, where pure liquid flows. From the sectional view of cross section, one can find that there is a double-vortex structure presented with their cores close together (see FIG. 12A). A more intense turbulent flow field causes the vortex cores to move away from each other, as shown in FIG. 12B. Note that, in the present flow and kinematic conditions, this is an unsteady vorticity field since the self-suctioned flow of air is pulsating. The turbulent kinetic energy field (see FIGS. 12B and 12D) reflects the radial velocity gradient in this structure. Note here that the colorbar for turbulent kinetic energy is scaled logarithmically. By comparison, the time-averaged flow field of the turbulence flow exhibits a similar distribution, even though increasing Q_{w} leads to the enlargement of high-magnitude region. The vortex that is generated naturally increases the turbulence intensity. From the sectional view of vertical section (top), the highest turbulence is found near the lower sidewall of the divergent section, where the bubble slug may break up into micro- or long bubbles and dissipate into the core flow field due to turbulent fluctuation in velocities, as shown in FIG. 3A. Whereas, the magnitude in the upper part of the divergent section is relatively small because it is mainly occupied by the backflow.

Based on the unprecedented configurations on plasma-microbubble reactor proposed in our previous work, 24 geometric parameters of the reactor are investigated in current work. For the degradation experiments, 500 mL aqueous STZ solution with the concentration of 10 mg/L is well prepared in the liquid container. Besides the variables of the diameter of air inlet for cavitation tube in Table 1, other parameters that are potential to affect the plasma activation process are listed in Table 3, involving the liquid flow rate (Q_{L}) and the distance of quartz (Lₐᵢᵣ).

To narrow the scope of the test, representative values from variables above are selected to conduct the orthogonal analysis. The aim is to evaluate the influence of various factors Table 6: All the comparative values in terms of design of cavitation tube, liquid flow rate (Q_{L}) and the distance between plasma nozzle and gas-liquid interface (Lₐᵢᵣ).

TABLE 6

| Cavitation tubes | Q_{L}(L/min) | Lₐᵢᵣ(cm) |
|---|---|---|
| Tube 1.5, Tube 2, | 2.5, 3, 4, 4.5, 5 | 5, 10, 15, 20, 25, 30 and 35 |
| Tube 2.5 and Tube 3 | 5.5, 6 and 6.5 | |

on plasma activation, based on the degradation efficiency of STZ after 30-min activation. Table 7 displays the experimental conditions in the orthogonal test. The diameter of air suction of cavitation tube (A, mm), Liquid flow rate (B, L/min) and length of the quartz tube (C, cm) are chosen as the orthogonal factors with 3 levels for each factor.

TABLE 7
Factors and level in the orthogonal experimental design

Factor Level

| Level | A (cavitation tube) | B (Q_{L}L/min) | C(Lₐᵢᵣ, cm) |
|---|---|---|---|
| 1 | Tube 1.5 (e = 1.5 mm) | 2.5 | 10 |
| 2 | Tube 2 (e = 2 mm) | 4 | 20 |
| 3 | Tube 3 (e = 3 mm) | 5 | 30 |

### Cultivation and Growth of Sprouts in Hydroponics

Soybean seeds are purchased from the local supermarket in Edmonton, Alberta, Canada. Four Soilless growing trays (Tesion, Canada) are ordered from Amazon. In each group, the same amount of seeds (200) are immersed in cold water and allowed them to soak overnight (at least 8 hours). Then cleaned seeds are placed on grid-shaped planters and covered by a soft tissue to prevent the moisture loss. After that, each two trays of bean-seeds are treated by PAW and pure water, respectively. PAW and pure water are filled at the bottom tray and sprinkled on a tissue every 4-8 h to keep seeds moist. When the roots stretched into the water surface through the grid, and seed germination is completed, then only the water supply to the bottom trays is required. Fresh PAW and pure water are provided every day for seedling growth. In the whole process, the damaged or dead seeds should be picked out in a timely manner. For the production of PAW, 1 L pure water is treated by plasma for 1 h continuously. Tube 3, liquid flow rate of 4 L/min and quartz tube with the length of 20 cm are used to produce PAW.

Peanut seeds (QMXC, China) and planting trays (Holibanna) are ordered from Amazon. 100 seeds are immersed in fresh tap water and allowed to soak for 8-10 h. After that, seeds are placed in the trays covered by the lid with the lightproof treatment and waited 6-7 days for germination. Depending on the quality of peanut seeds, only 72% seeds are successfully germinated and separated into two groups as the initial seeds for the irrigation of PAW (36 seeds) and tap water (36 seeds). Germinated seeds with around 1 cm root are placed into the corresponding grid container and fed with tap water and PAW, respectively. 500 mL tap water is treated with cold plasma for 30 min. Tube 3, liquid flow rate of 4 L/min and quartz tube with the length of 20 cm are used for PAW production. In order to obtain the dry weight of peanut seedling, the harvest products are heated in the oven for 8 h at the temperature of 90° C.

### Design of Solar-Driven Portable Device for PAW Production

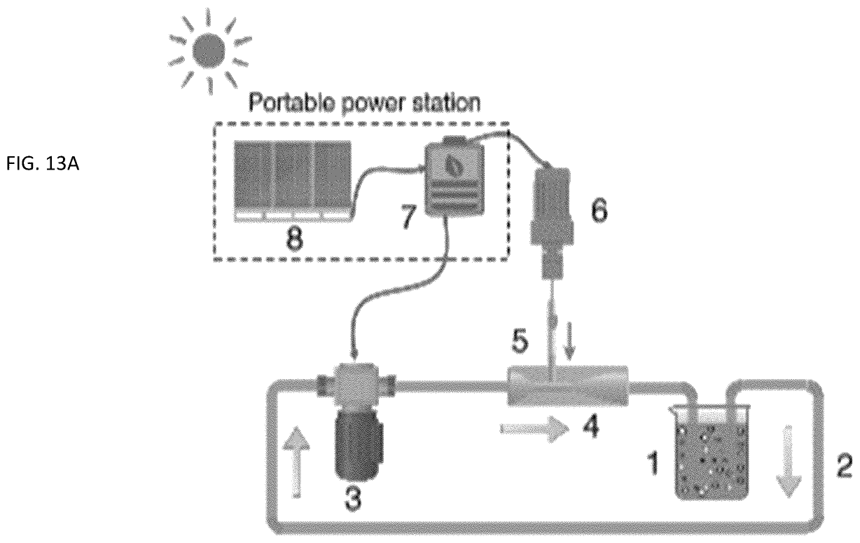

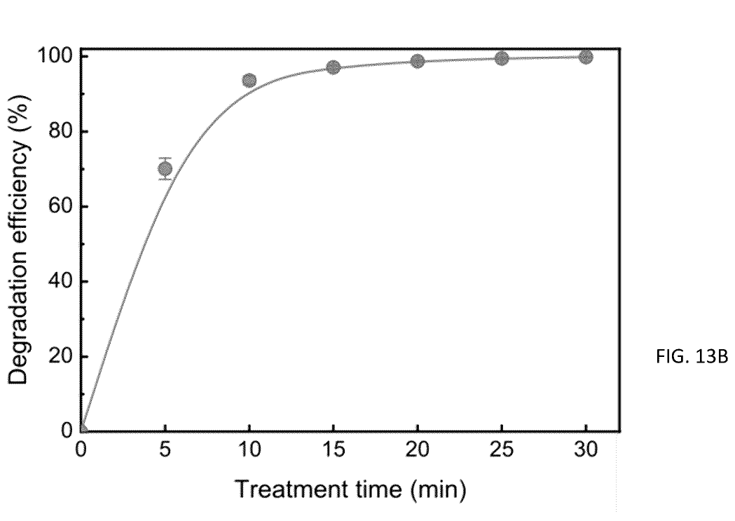

FIG. 13A shows a schematic setup of the portable devices for PAW product. The devices consist of a plasma nozzle, peristaltic pump and a cavitation tube, a container and tubes. A portable power station charged by a piece of solar panel with surface area (1.6 m×0.54 m) is employed to provide power for both the plasma generator and the circulation system (FIG. 13A). Gas is sucked from the atmosphere at the air inlet of the cavitation tube, ionized by the plasma generator and transferred to the liquid flow in the quartz tube due to the pressure difference. Reactive species in the gas flow in the cavitation tube and formed in microbubbles in water. The self-suction mechanism enables intake of gas phase into water without requirements for a gas cylinder or a gas pump. Due to the simplicity of our system, PAW production may be achieved by a portable device for outdoor applications.

According to embodiments, the device is a portable outdoor setup with a solar power station. The solar panel is placed under the sun to continuously charge the station. The degradation experiment of methyl orange solution treatment is conducted to test the activation efficiency of the whole setup. The output electric energy from the battery for activation devices is 80 watt, and the power supplied by solar panels provided 63 watt at the same time. Running degradation for 30 min might consume a quarter of the electricity stocked in the battery. The energy consumption of our setup is sufficiently low that solar panels can provide enough power for the activation setup. Therefore this portable activation system with zero energy consumption can be installed for field applications, such as in greenhouses.

After treated for 15 min and 30 min, the degradation efficiency reached 97.11% and 99.82%, respectively. The treated solution became entirely colorless and transparent after treated for 30 min. The plot in FIG. 13B shows the degradation efficiency of MO increased to 70.07% after treatment for 5 min and 93.60% for 10 min, respectively. Thus, the portable device can achieve PAW production by using sunlight, air and water.

### PAW for Enhanced Growth of Plants

To demonstrate the function of PAW, the sprout growth of soybean watering with PAW and pure water is evaluated. The distribution of sprouts, in terms of stem length (cm) achieved after 1-cycle cultivation for 16 days. A considerable difference on the sprout growth treated by both water matrix in the hydroponic system is observed. The growth of sprouts fed by PAW grew faster and had healthier performance, compared to the sprouts treated by pure water. The seedling from the PAW-treated trays are much denser and a larger area covered by green sprouts than the control. Meanwhile, more damaged seeds appeared and became moldy in the trays fed with pure water. Twenty seedlings are randomly selected from corresponding two trays and measured on the length of stem. The average length of sprout watering with PAW and pure water is 8.13 cm and 4.52 cm, respectively. Under the irrigation of water matrix on the same period, PAW accelerates the growth of sprouts for 1.8 times compared to tap water.

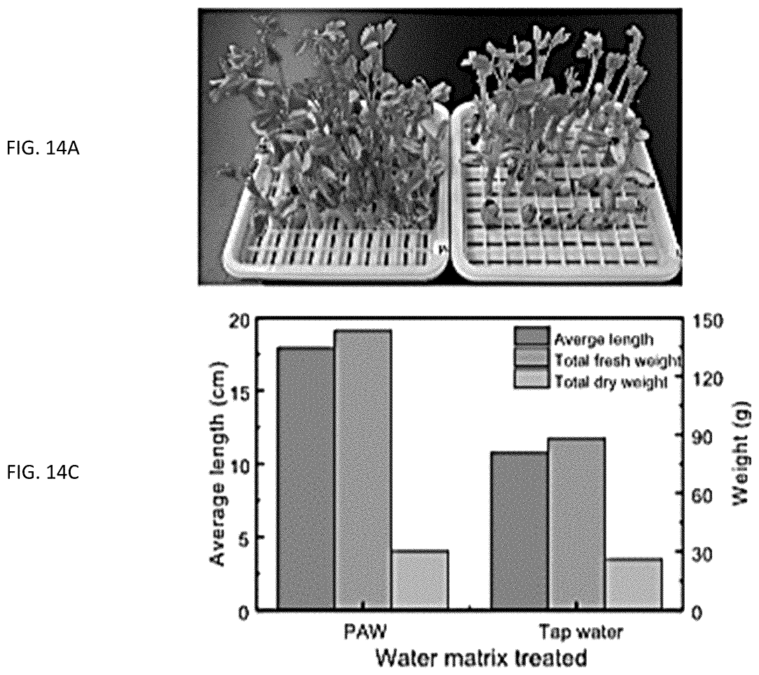

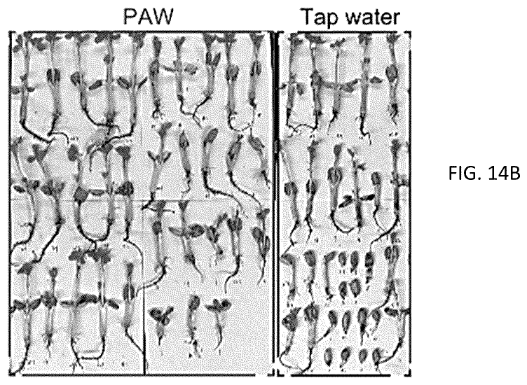

PAW and normal tap water are used to demonstrate the effectiveness of PAW on growth rate of peanut sprouts. FIG. 14A shows snapshots of peanut sprouts fed with PAW (left) and tap water (right) after 26 days cultivation. Leaves of peanut sprouts in PAW are more luxuriant than in tap water, showing broad foliage and less back bacteria spots on the seed surface. The harvest products in FIG. 14B shows that peanuts irrigated by PAW have stronger sprouts with longer roots of high quality. According to FIG. 14C, length and fresh weight in PAW are 1.66 times longer and 1.63 times heavier than the sprouts in tap water, respectively. After drying process, the weight in PAW is 4.23 g heavier than the product cultivated by tap water.

The reactive oxygen and nitrogen species (RONS) presented in PAW could potentially aid the plant growth due to the enrichment of H₂O₂, O₃, ·OH, NH⁺₄, NO₂ and NO₃. Previous works have shown that NO₃⁻ ions provide the essential nitrogen nutrient and implicate in regulating metabolism and development in plants.

For both soybean and peanut, nitrogen species in PAW work as a liquid fertilizer, which saves the cost on the nutrient additions during the cultivation period. Accumulation of H₂O₂ and its positive effect on plant respiration and metabolic activities have been reported. Moreover, PAW offers an environmentally friendly disinfection agent via deactivating the bacterial.

### CONCLUSIONS

We demonstrate that a novel design that integrates cold plasma treatment and microbubbles in a Venturi tube can achieve significantly high efficiency for activation of water in a flow. Based on the results of dyestuff degradation and CFD simulations, special vortex flows formed in a Venturi tube efficiently enhance the dissolution and mass transfer of reactive species from the gas phase to the liquid phase. The design has unique advantages in that water to be treated is in a flow, and the activation process can be readily scaled up with low energy consumption. Discharge power, treatment time, the type of prepared water and flow rate of water impact activation efficiency as represented by the degradation of the model compound. Future studies on the characteristics of specific species in PAW, the degradation of different chemical pollutants, and wider applications should be carried out to explore more feasibility.

Patent documents and publications mentioned in the specification are indicative of the levels of those skilled in the art to which the invention pertains. These documents and publications are incorporated herein by reference to the same extent as if each individual document or publication is specifically and individually incorporated herein by reference.

The foregoing description is illustrative of particular embodiments of the invention but is not meant to be a limitation upon the practice thereof. The following claims, including all equivalents thereof, are intended to define the scope of the invention.

### REFERENCES

1. B. Jiang, J. Zheng, S. Qiu, M. Wu, Q. Zhang, Z. Yan, Q. Xue, Review On Electrical Discharge Plasma Technology For Wastewater Remediation, Chemical Engineering Journal 236 (2014) 348-368.
2. Y. Jin, Y. Wu, J. Cao, Y. Wu, Optimizing decolorization of methylene blue and methyl orange dye by pulsed discharged plasma in water using response surface methodology, Journal of the Taiwan Institute of Chemical Engineers 45 (2) (2014) 589-595.
3. N. A. Youssef, S. A. Shaban, F. A. Ibrahim, A. S. Mahmoud, Degradation of methyl orange using fenton catalytic reaction, Egyptian Journal of Petroleum 25 (3) (2016) 317-321.
4. X. Qian, L. Xu, Y. Zhu, H. Yu, J. Niu, Removal of aqueous triclosan using tio2 nanotube arrays reactive membrane by sequential adsorption and electrochemical degradation, Chemical Engineering Journal 420 (2021) 127615.
5. G. R. Stratton, C. L. Bellona, F. Dai, T. M. Holsen, S. M. Thagard, Plasma-based water treatment: Conception and application of a new general principle for reactor design, Chemical Engineering Journal 273 (2015) 543-550.
6. K.-S. Kim, S. K. Kam, Y. S. Mok, Elucidation of the degradation pathways of sulfonamide antibiotics in a dielectric barrier discharge plasma system, Chemical Engineering Journal 271 (2015) 31-42.
7. A. T. Sugiarto, S. Ito, T. Ohshima, M. Sato, J. D. Skalny, Oxidative decoloration of dyes by pulsed discharge plasma in water, Journal of Electrostatics 58 (1-2) (2003) 135-145.
8. E. S. M. Mouele, J. O. Tijani, K. O. Badmus, O. Pereao, O. Babajide, O. O. Fatoba, C. Zhang, T. Shao, E. Sosnin, V. Tarasenko, et al., A critical review on ozone and co-species, generation and reaction mechanisms in plasma induced by dielectric barrier discharge technologies for wastewater remediation, Journal of Environmental Chemical Engineering (2021) 105758.
9. Q. Xiang, L. Fan, Y. Li, S. Dong, K. Li, Y. Bai, A review on recent advances in plasma-activated water for food safety: Current applications and future trends, Critical Reviews in Food Science and Nutrition (2020) 1-20.
10. M. Darmanin, D. Kozak, J. de Oliveira Mallia, R. Blundell, R. Gatt, V. P. Valdramidis, Generation of plasma functionalized water: Antimicrobial assessment and impact on seed germination, Food Control 113 (2020) 107168.
11. K. Lotfy, N. A. Al-Harbi, H. Abd El-Raheem, Cold atmospheric pressure nitrogen plasma jet for enhancement germination of wheat seeds, Plasma Chemistry and Plasma Processing 39 (4) (2019) 897-912.
12. C. Sarangapani, L. Scally, M. Gulan, P. Cullen, Dissipation of pesticide residues on grapes and strawberries using plasma-activated water, Food and Bioprocess Technology 13 (10) (2020) 1728-1741.
13. L. Lin, X. Liao, C. Li, M. A. Abdel-Samie, H. Cui, Inhibitory effect of cold nitrogen plasma on Salmonella Typhimurium biofilm and its application on poultry egg preservation, LWT-Food Science and Technology 126 (2020) 109340.
14. V. Stoleru, R. Burlica, G. Mihalache, D. Dirlau, S. Padureanu, G. C. Teliban, D. Astanei, A. Cojocaru, O. Beniuga, A. Patras, Plant growth promotion effect of plasma activated water on Lactuca sativa L. cultivated in two different volumes of substrate, Scientific Reports 10 (1) (2020) 1-13.
15. L. Grabowski, E. Van Veldhuizen, A. Pemen, W. Rutgers, Breakdown of methylene blue and methyl orange by pulsed corona discharge, Plasma Sources Science and Technology 16 (2) (2007) 226.
16. V. Scholtz, J. Julák, V. Kríha, J. Mosinger, Decontamination effects of low-temperature plasma generated by corona discharge. part I: an overview, Prague Medical Report 108 (2) (2007) 115-27.
17. R. Brandenburg, Dielectric barrier discharges: progress on plasma sources and on the understanding of regimes and single filaments, Plasma Sources Science and Technology 26 (5) (2017) 053001.
18. R. Zhou, R. Zhou, P. Wang, Y. Xian, A. Mai-Prochnow, X. Lu, P. Cullen, K. K. Ostrikov, K. Bazaka, Plasma-activated water: generation, origin of reactive species and biological applications, Journal of Physics D: Applied Physics 53 (30) (2020) 303001.
19. T. Ishijima, H. Sugiura, R. Saito, H. Toyoda, H. Sugai, Efficient production of microwave bubble plasma in water for plasma processing in liquid, Plasma Sources Science and Technology 19 (1) (2009) 015010.
20. P. M. K. Reddy, B. R. Raju, J. Karuppiah, E. L. Reddy, C. Subrahmanyam, Degradation and mineralization of methylene blue by dielectric barrier discharge non-thermal plasma reactor, Chemical Engineering Journal 217 (2013) 41-47.
21. K. Bae, G. S. Go, N. S. Noh, Y.-I. Lim, J. Bae, D. H. Lee, Bubble characteristics in pressurized bubble column associated with microbubble dispersion, Chemical Engineering Journal 386 (2020) 121339.
22. D. Lohse, X. Zhang, et al., Surface nanobubbles and nanodroplets, Reviews of Modern Physics 87 (3) (2015) 981.
23. M.-C. Wu, S. Uehara, J.-S. Wu, Y. Xiao, T. Nakajima, T. Sato, Dissolution enhancement of reactive chemical species by plasma-activated microbubbles jet in water, Journal of Physics D: Applied Physics 53 (48) (2020) 485201.

24 A. J. Atkinson, O. G. Apul, O. Schneider, S. Garcia-Segura, P. Westerhoff, Nanobubble technologies offer opportunities to improve water treatment, Accounts of Chemical Research 52 (5) (2019) 1196-1205.
25. H. Zhang, P. Li, A. Zhang, Z. Sun, J. Liu, P. Héroux, Y. Liu, Enhancing interface reactions by introducing microbubbles into a plasma treatment process for efficient decomposition of PFOA, Environmental Science & Technology 55 (23) (2021) 16067-16077.
26. A. Yamatake, H. Katayama, K. Yasuoka, S. Ishii, Water purification by atmospheric DC/pulsed plasmas inside bubbles in water, International Journal of Plasma Environmental Science & Technology 1 (1) (2007) 91-95.
27. C. Wang, G. Qu, T. Wang, F. Deng, D. Liang, Removal of tetracycline antibiotics from wastewater by pulsed corona discharge plasma coupled with natural soil particles, Chemical Engineering Journal 346 (2018) 159-170.
28. T. Zhang, R. Zhou, P. Wang, A. Mai-Prochnow, R. McConchie, W. Li, R. Zhou, E. W. Thompson, K. K. Ostrikov, P. J. Cullen, Degradation of cefixime antibiotic in water by atmospheric plasma bubbles: Performance, degradation pathways and toxicity evaluation, Chemical Engineering Journal 421 (2021) 127730.
29. K.-S. Kim, C.-S. Yang, Y. Mok, Degradation of veterinary antibiotics by dielectric barrier discharge plasma, Chemical Engineering Journal 219 (2013) 19-27.
30. M. Hijosa-Valsero, R. Molina, H. Schikora, M. Müller, J. M. Bayona, Removal of cyanide from water by means of plasma discharge technology, Water Research 47 (4) (2013) 1701-1707.
31. Y. Liu, H. Zhang, J. Sun, J. Liu, X. Shen, J. Zhan, A. Zhang, S. Ognier, S. Cavadias, P. Li, Degradation of aniline in aqueous solution using non-thermal plasma generated in microbubbles, Chemical Engineering Journal 345 (2018) 679-687.
32. R. Zhou, R. Zhou, P. Wang, B. Luan, X. Zhang, Z. Fang, Y. Xian, X. Lu, K. K. Ostrikov, K. Bazaka, Microplasma bubbles: reactive vehicles for biofilm dispersal, ACS Applied Materials & Interfaces 11 (23) (2019) 20660-20669.
33. T. Shibata, A. Ozaki, H. Takana, H. Nishiyama, Water treatment characteristics using activated air microbubble jet with photochemical reaction, Journal of Fluid Science and Technology 6 (2) (2011) 242-251.
34. Y. Gao, A. M. Dashliborun, J. Z. Zhou, X. Zhang, Formation and stability of cavitation microbubbles in process water from the oilsands industry, Industrial & Engineering Chemistry Research 60 (7) (2021) 3198-3209.
35. X. Wang, J. Wang, P. Guo, W. Guo, G. Li, Chemical effect of swirling jet-induced cavitation: Degradation of rhodamine b in aqueous solution, Ultrasonics Sonochemistry 15 (4) (2008) 357-363.
36. S. G. Sontti, A. Atta, Numerical insights on controlled droplet formation in a microfluidic flow-focusing device, Industrial & Engineering Chemistry Research 59 (9) (2019) 3702-3716.
37. S. G. Sontti, A. Atta, Formation characteristics of taylor bubbles in power-law liquids flowing through a microfluidic co-flow device, Journal of Industrial and Engineering Chemistry 65 (2018) 82-94.
38. S. G. Sontti, A. Atta, Cfd analysis of taylor bubble in a co-flow microchannel with newtonian and non-newtonian liquid, Industrial & Engineering Chemistry Research 56 (25) (2017) 7401-7412.
39. C. W. Hirt, B. D. Nichols, Volume of fluid (vof) method for the dynamics of free boundaries, Journal of Computational Physics 39 (1) (1981) 201-225.
40. D. Adalsteinsson, J. A. Sethian, A fast level set method for propagating interfaces, Journal of Computational Physics 118 (2) (1995) 269-277.
41. M. Ashokkumar, The characterization of acoustic cavitation bubbles—an overview, Ultrasonics Sonochemistry 18 (4) (2011) 864-872.
42. P. Bruggeman, M. J. Kushner, B. R. Locke, J. G. Gardeniers, W. Graham, D. B. Graves, R. Hofman-Caris, D. Maric, J. P. Reid, E. Ceriani, et al., Plasma-liquid interactions: a review and roadmap, Plasma Sources Science and Technology 25 (5) (2016) 053002.
43. R. Zhou, T. Zhang, R. Zhou, A. Mai-Prochnow, S. B. Ponraj, Z. Fang, H. Masood, J. Kananagh, D. McClure, D. Alam, et al., Underwater microplasma bubbles for efficient and simultaneous degradation of mixed dye pollutants, Science of the Total Environment 750 (2021) 142295.
44. B. Sun, N. N. Aye, Z. Gao, D. Lv, X. Zhu, M. Sato, Characteristics of gas-liquid pulsed discharge plasma reactor and dye decoloration efficiency, Journal of Environmental Sciences 24 (5) (2012) 840-845.
45. H. Lee, S. H. Park, C.-J. Cheong, S.-J. Kim, S.-G. Seo, Y.-K. Park, S. C. Jung, Contribution of dissolved oxygen to methyl orange decomposition by liquid phase plasma processes system, Ozone: Science & Engineering 36 (3) (2014) 244-248.
46. P. Attri, M. Yusupov, J. H. Park, L. P. Lingamdinne, J. R. Koduru, M. Shiratani, E. H. Choi, A. Bogaerts, Mechanism and comparison of needle-type non-thermal direct and indirect atmospheric pressure plasma jets on the degradation of dyes, Scientific Reports 6 (1) (2016) 1-14.
47. P. Li, Y. Song, S. Wang, Z. Tao, S. Yu, Y. Liu, Enhanced decolorization of methyl orange using zero-valent copper nanoparticles under assistance of hydrodynamic cavitation, Ultrasonics Sonochemistry 22 (2015) 132-138.
48. M. Takahashi, K. Chiba, P. Li, Free-radical generation from collapsing microbubbles in the absence of a dynamic stimulus, The Journal of Physical Chemistry B 111 (6) (2007) 1343-1347.
49. A. Ciesielska, W. Ciesielski, H. Kołoczek, D. Kulawik, J. Kończyk, Z. Oszczęda, P. Tomasik, Structure and some physicochemical and functional properties of water treated under ammonia with low temperature low-pressure glow plasma of low frequency, Open Chemistry 18 (1) (2020) 1195-1206.
50. K. Wright, H. Kim, D. Cho, A. Rabinovich, A. Fridman, Y. Cho, New fouling prevention method using a plasma gliding arc for produced water treatment, Desalination 345 (2014) 64-71.
51. Y. Yang, H. Kim, A. Starikovskiy, A. Fridman, Y. I. Cho, Application of pulsed spark discharge for calcium carbonate precipitation in hard water, Water Research 44 (12) (2010) 3659-3668.
52. A. Berardinelli, F. Pasquali, C. Cevoli, M. Trevisani, L. Ragni, R. Mancusi, G. Manfreda, Sanitisation of fresh-cut celery and radicchio by gas plasma treatments in water medium, Postharvest Biology and Technology 111 (2016) 297-304.
53. H. Guo, N. Jiang, H. Wang, K. Shang, N. Lu, J. Li, Y. Wu, Degradation of flumequine in water by pulsed discharge plasma coupled with reduced graphene oxide/tio2 nanocomposites, Separation and Purification Technology 218 (2019) 206-216.
54. Y. Xu, Y. Tian, R. Ma, Q. Liu, J. Zhang, Effect of plasma activated water on the postharvest quality of button mushrooms, Agaricus bisporus, Food Chemistry 197 (2016) 436-444.
55. A. Mai-Prochnow, D. Alam, R. Zhou, T. Zhang, K. Ostrikov, P. J. Cullen, Microbial decontamination of chicken using atmospheric plasma bubbles, Plasma Processes and Polymers 18 (1) (2021) 2000052.
56. D. Liu, Z. Liu, C. Chen, A. Yang, D. Li, M. Rong, H. Chen, M. Kong, Aqueous reactive species induced by a surface air discharge: Heterogeneous mass transfer and liquid chemistry pathways, Scientific Reports 6 (1) (2016) 1-11.
57. J. Fontmorin, R. B. Castillo, W. Tang, M. Sillanpää, Stability of 5, 5dimethyl-1-pyrroline-n-oxide as a spin-trap for quantification of hydroxyl radicals in processes based on fenton reaction, Water Research 99 (2016) 24-32.
58. R. A. Floyd, L. M. Soong, Spin trapping in biological systems. oxidation of the spin trap 5, 5-dimethyl-1-pyrroline-1-oxide by a hydroperoxide-hematin system, Biochemical and Biophysical Research Communications 74 (1) (1977) 79-84.
59. S. D. Stan, M. A. Daeschel, 5, 5-dimethyl-2-pyrrolidone-n-oxyl formation in electron spin resonance studies of electrolyzed NaCl solution using 5, 5-dimethyl-1-pyrroline-n-oxide as a spin trapping agent, Journal of Agricultural and Food Chemistry 53 (12) (2005) 4906-4910.
60. C. Chen, F. Li, H.-L. Chen, M. G. Kong, Interaction between air plasma-produced aqueous 1O2 and the spin trap DMPO in electron spin resonance, Physics of Plasmas 24 (10) (2017) 103501.
61. F. Judée, S. Simon, C. Bailly, T. Dufour, Plasma-activation of tap water using DBD for agronomy applications: Identification and quantification of long lifetime chemical species and production/consumption mechanisms, Water Research 133 (2018) 47-59.
62. P. Rudolf, M. Hudec, M. Gríger, D. S̆tefan, Characterization of the cavitating flow in converging-diverging nozzle based on experimental investigations, in: EPJ Web of conferences, Vol. 67, EDP Sciences, 2014, p. 02101.
63. A. Simpson, V. V. Ranade, 110th anniversary: comparison of cavitation devices based on linear and swirling flows: hydrodynamic characteristics, Industrial & Engineering Chemistry Research 58 (31) (2019) 14488-14509.

1. A high efficiency plasma activation system for large scale treatment of liquid, the system comprising:
a liquid tank having an inlet and an outlet;
a pump having an inlet and an outlet, the inlet of the pump fluidly connected to the outlet of the liquid tank;
a self-suction mechanism having a liquid inlet fluidly connected to the outlet of the pump, an air inlet, and an outlet fluidly connected to the inlet of the liquid tank, the liquid inlet, the air inlet, and the outlet joined at a throat; and
a plasma generator having a plasma discharge nozzle positioned adjacent to the air inlet of the self-suction mechanism and configured to discharge gas phase plasma into the air inlet of the self-suction mechanism and introduce micro/nano bubbles (MNBs) into a flow of liquid to be treated to where the MNBs collapse to agitate and impregnate the liquid with a gas.

2. The high efficiency plasma activation system of claim 1 wherein the inlet of the liquid tank is connected to a supply of liquid to be treated.

3. The high efficiency plasma activation system of claim 1 wherein the system is a closed loop system.

4. The high efficiency plasma activation system of claim 1 wherein the pump controls a liquid flow rate of the system, the liquid flow rate of the system being between 50 mL/min to 200 L/min.

5. The high efficiency plasma activation system of claim 1 wherein the self-suction mechanism is a Venturi tube.

6. The high efficiency plasma activation system of claim 5 wherein the Venturi tube is formed using 3D printing.

7. The high efficiency plasma activation system of claim 1 wherein the air inlet of the self-suction mechanism has an inner diameter of 1 to 4 mm.

8. The high efficiency plasma activation system of claim 1 wherein the air inlet of the self-suction mechanism has a length of 5 mm to 20 mm.

9. The high efficiency plasma activation system of claim 1 wherein the outlet of the self-suction mechanism has a length of 5 mm to 80 mm.

10. The high efficiency plasma activation system of claim 1 wherein the plasma discharge nozzle works in a range of voltage and frequency.

11. The high efficiency plasma activation system of claim 1 further comprising a plurality of liquid-transmitting pipes that fluidly connect each of the liquid tank, the pump, and the self-suction mechanism.

12. The high efficiency plasma activation system of claim 11 wherein the liquid-transmitting pipes have a light resistant coating applied thereto.

13. The high efficiency plasma activation system of claim 1 wherein the system is configured to operate at room temperature.

14. The high efficiency plasma activation system of claim 1 wherein the system has a degradation efficiency of 80% after two hours of treatment in the system.

15. The high efficiency plasma activation system of claim 1 further comprising a power source configured to provide electrical power to the plasma generator and the pump.

16. The high efficiency plasma activation system of claim 1 wherein the system is portable.

17. The high efficiency plasma activation system of claim 1 wherein the plasma generator comprises an electrode that is spatially separated from any liquid of the system.

18. The high efficiency plasma activation system of claim 1 where the gas phase plasma includes nitrogen and oxygen therein.

19. The high efficiency plasma activation system of claim 1 wherein the liquid is water.

20. The high efficiency plasma activation system of claim 1 wherein the system is free of compressed gas.
